(19) United States
(12) Patent Application Publication
(10) Pub. No.: US 2008/0104219 A1
(43) Pub. Date: May 1, 2008

(54) Content Sharing System, Content Management Server, Client Station, Method for Managing Content, Method for Acquiring Content, and Program

(76) Inventors: Yuichi Kageyama, Tokyo (JP); Yasuaki Honda, Chiba (JP); Atsushi Onoe, Kanagawa (JP); Kazuto Horimatsu, Kanagawa (JP); Norifumi Kikkawa, Tokyo (JP); Junichi Nakata, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/877,872

(22) Filed: Oct. 24, 2007

(30) Foreign Application Priority Data
Oct. 26, 2006 (JP) P2006-290800

(51) Int. Cl. G06F 15/173

(52) U.S. Cl. 709/223

(57) ABSTRACT

A content sharing system includes a plurality of client stations, each including a content acquiring unit, and one or more content management servers that manage a plurality of content items. The content management server includes a storage unit that stores meta data of the content items, a tree structure generating unit that generates a tree structure including a plurality of containers arranged in hierarchical levels, each container having an identifier representing a type of content assigned thereto, a content allocating unit that allocates the content items to the containers on the basis of the meta data and the identifiers, and a content presenting unit that presents the tree structure having the content items allocated thereto to the client station. The content acquiring unit acquires the tree structure from the content management server and acquires the one or more content items from the content management server using the acquired tree structure.

### CROSS REFERENCES TO RELATED APPLICATIONS

The present invention contains subject matter related to Japanese Patent Application JP 2006-290800 filed in the Japanese Patent Office on Oct. 26, 2006, the entire contents of which are incorporated herein by reference.

### BACKGROUND OF THE INVENTION

1. Field of the Invention

The present invention relates to a content sharing system, a content management server, a client station, a method for managing content, a method for acquiring content, and a program.

2. Description of the Related Art

Recently, with the widespread use of data communication networks, consumer electronics products, computers, and other peripherals are typically connected to a network so as to communicate with each other. That is, networks known as home networks have come into widespread use. A home network enables communications between the apparatuses via the network so that the data processing functions of the apparatuses can be shared and content can be transmitted and received between the apparatuses. Thus, a home network can provide users with convenience and comfort. Accordingly, the use of home networks is expected to become increasingly more widespread in the future.

In particular, in order to increase convenience of content management, these apparatuses share content. To share content, when the apparatuses transmit and receive the content, an identifier (ID) is assigned to the content in order to uniquely identify from all the contents to be shared. The identifier remains unchanged after the content is transmitted to a different apparatus (refer to, for example, Japanese Unexamined Patent Application Publication No. 2004-234158).

### SUMMARY OF THE INVENTION

However, in the management method described in Japanese Unexamined Patent Application Publication No. 2004-234158, an apparatus (hereinafter referred to as a “server”) that manages the content does not manage the locations of the content systematically. Accordingly, when an apparatus (hereinafter referred to as a “client station”) searches for desired content, the client station needs to search the entirety of a data structure inside the server. Therefore, the efficiency of searching for desired content is undesirably low.

Accordingly, the present invention provides a novel and improved content sharing system, a content management server, a client station, a method for managing content, a method for acquiring content, and a program that allow a client station to efficiently acquire desired content and the attribute information about the content.

According to an embodiment of the present invention, a content sharing system including a plurality of client stations, each including a content acquiring unit, and one or more content management servers that manage a plurality of content items is provided. The client stations share the plurality of content items. The content management server includes a storage unit configured to store meta data of the content items, a tree structure generating unit configured to generate a tree structure including a plurality of containers arranged in hierarchical levels, each container having an identifier representing a type of content assigned thereto, a content allocating unit configured to allocate the content items to the containers on the basis of the meta data and the identifier, and a content presenting unit configured to present the tree structure having the content items allocated thereto to the client station. The content acquiring unit acquires the tree structure from the content management server and acquires the one or more content items from the content management server on the basis of the acquired tree structure.

In such a configuration, the storage unit of the content management server stores meta data of the content items. The tree structure generating unit of the content management server generates a tree structure including a plurality of containers arranged in hierarchical levels, each container having an identifier representing a type of content assigned thereto. The content allocating unit of the content management server allocates the content items to the containers on the basis of the meta data and the identifier. The content presenting unit of the content management server presents the tree structure having the content items allocated thereto to the client station. The content acquiring unit of the client station acquires the tree structure from the content management server and acquires the one or more content items from the content management server on the basis of the acquired tree structure. By connecting the content management server and the client station with each other, the content can be shared. Thus, the client station can efficiently acquire content from among the content managed by the content management server.

According to another embodiment of the present invention, a content management server is provided that manages a plurality of content items and provides meta data of the content items to a client station in response to a request from the client station. The content management server includes a storage unit configured to store the meta data, a tree structure generating unit configured to generate a tree structure including a plurality of containers arranged in hierarchical levels, each container having an identifier representing a type of content assigned thereto, a content allocating unit configured to allocate the content items to the containers on the basis of the meta data and the identifier, and a content presenting unit configured to present the tree structure having the content items allocated thereto to the client station.

In such a configuration, the storage unit stores the meta data of the content items. The tree structure generating unit generates a tree structure including a plurality of containers arranged in hierarchical levels, each container having an identifier representing a type of content assigned thereto. The content allocating unit allocates the content items to the containers on the basis of the meta data and the identifier. The content presenting unit presents the tree structure having the content items allocated thereto to the client station. By assigning the identifiers to the containers contained in the tree structure, the content management server can systematically manage the content items.

The above-described identifier can be an identifier that is assigned to a container of interest in order to indicate the type of containers or the type of content disposed in the levels lower than that of the container of interest. In such a configuration, the identifier assigned to a container represents the category of containers or the type of content disposed in the levels lower than that of the container of interest. By assigning the identifiers to the containers contained in the tree structure in such a manner, the content management server can systematically manage the content items.

The content allocating unit can allocate one of the content items to a plurality of containers contained in the tree structure on the basis of the identifier. In such a configuration, if a plurality of possible containers to be allocated, the content allocating unit allocates one of the content items to all the possible containers in which the content is disposed. By allocating the content to the containers in such a manner, the content allocating unit can efficiently allocate the content to the tree structure.

The meta data can include attribute information about the content item and location information about the content item.

The content management server can further include a content acquiring unit configured to acquire a new content item from outside the content management server. In such a configuration, the content acquiring unit acquires a new content item from outside the content management server. By including the content acquiring unit, the content management server can acquire content by itself and manage the content.

The number of levels of the tree structure can be less than or equal to 10. In such a configuration, the maximum level of the tree structure is 10. By limiting the number of levels of the tree structure to 10, the client station accessing the content management server can efficiently acquire the content.

The levels of the tree structure can include levels in which only the containers are disposed and levels in which both the containers and the content items are disposed. In such a structure, the tree structure contains levels in which only the containers are disposed and levels in which both the containers and the content items are disposed. By defining the level in which the containers and the content items can be disposed, any content can be disposed in the level in which only content is originally disposed.

An identifier used for grouping the content items on the basis of the type of content item can be assigned to a container included in a second level of the tree structure. In such a structure, a container having an identifier based on the type of content is disposed in the second level of the tree structure.

An identifier used for grouping the content items on the basis of the attribute information about the content item contained in the meta data can be assigned to a container included in a third level of the tree structure. In such a structure, a container having an identifier based on the attribute information contained in the meta data of the content item is disposed in the third level of the tree structure.

According to still another embodiment of the present invention, a client station communicatable with a content management server is provided. The client station includes a content acquiring unit configured to request the content management server to present a tree structure generated by the content management server. The tree structure includes a plurality of containers arranged in hierarchical levels, each container having an identifier indicating the type of content item. The content acquiring unit acquires the tree structure so as to acquire one of the content items on the basis of the acquired tree structure.

In such a configuration, the content acquiring unit requests the content management server to present a tree structure generated by the content management server and including a plurality of containers arranged in hierarchical levels, each container having an identifier indicating the type of content item. The content acquiring unit acquires the tree structure so as to acquire one of the content items on the basis of the acquired tree structure. Since the client station acquires the content using the systematically generated tree structure, the client station can efficiently acquire the content.

The content acquiring unit can search the tree structure using the identifiers assigned to the containers so as to acquire the meta data of the one of the content items and acquire the one of the content items. In such a configuration, since the client station searches the tree structure using the identifiers assigned to the containers, the client station need not search the entirety of the tree structure. Accordingly, the client station can efficiently search for the one of the content items.

The content acquiring unit can generate a content list of the content items managed by the content management server on the basis of the meta data acquired from the content management server.

The client station can further include a content executing unit configured to execute the content item acquired by the content acquiring unit.

According to yet still another embodiment of the present invention, a method for managing a plurality of content items is provided. The method includes the steps of generating a tree structure including a plurality of containers arranged in hierarchical levels, where each container has an identifier representing a type of content assigned thereto, allocating the content items to the containers on the basis of the meta data of the content items and the identifiers, and presenting the tree structure having the content items allocated thereto to a client station in response to a request from the client station.

In such a method, a tree structure including a plurality of containers arranged in hierarchical levels is generated in the generating step, where each container has an identifier representing a type of content assigned thereto. The content items are allocated to the containers on the basis of the meta data and the identifier in the allocating step. The tree structure having the content items allocated thereto is presented to the client station in the presenting step.

According to yet still another embodiment of the present invention, a method for acquiring content from a content management server through communication with the content management server is provided. The method includes the steps of requesting the content management server to present a tree structure generated by the content management server, where the tree structure includes a plurality of containers arranged in hierarchical levels, each container having an identifier indicating the type of content item, so as to acquire the tree structure and acquiring one of the content items on the basis of the acquired tree structure.

In such a method, a tree structure generated by the content management server is requested to the content management server, where the tree structure includes a plurality of containers arranged in hierarchical levels, each container having an identifier indicating the type of content item, so that the tree structure is acquired in the step of requesting a tree structure and acquiring the tree structure. The content item is acquired on the basis of the acquired tree structure in the step of acquiring content.

According to yet still another embodiment of the present invention, a computer-readable program is provided. The computer-readable program includes program code for causing a computer to execute the steps of storing meta data of content, generating a tree structure including a plurality of containers arranged in hierarchical levels, each container having an identifier representing a type of content assigned thereto, allocating the content to the containers on the basis of the meta data and the identifier, and presenting the tree structure having the content allocated thereto to a client station.

In such a configuration, the computer-readable program is stored in a storage unit of the computer. The computer-readable program is read out by a CPU of the computer and is executed. Thus, the computer-readable program causes the computer to function as the content management server. In addition, a computer-readable recording medium storing the computer-readable program can be provided. Examples of the recording medium include a magnetic disk, an optical disk, a magnetooptical disk, and a flash memory. The computer-readable program may be distributed via, for example, a network without using the recording medium.

According to yet still another embodiment of the present invention, a computer-readable program includes program code for causing a computer to execute the steps of requesting a content management server to present a tree structure generated by the content management server, where the tree structure includes a plurality of containers arranged in hierarchical levels, each container having an identifier indicating a type of content item, so as to acquire the tree structure and acquiring one of the content items on the basis of the acquired tree structure.

In such a configuration, the computer-readable program is stored in a storage unit of the computer. The computer-readable program is read out by a CPU of the computer and is executed. Thus, the computer-readable program causes the computer to function as the client station. In addition, a computer-readable recording medium storing the computer-readable program can be provided. Examples of the recording medium include a magnetic disk, an optical disk, a magnetooptical disk, and a flash memory. The computer-readable program may be distributed via, for example, a network without using the recording medium.

According to the above-described embodiments of the present invention, when the client station acquires content or a content list from a content management server, the client station can efficiently acquire the desired content and the meta data of the content from the content management server.

### BRIEF DESCRIPTION OF THE DRAWINGS

FIG. 1 is a diagram illustrating a content sharing system according to an exemplary embodiment of the present invention;

FIG. 2 is a block diagram illustrating an example hardware configuration of a content management server according to the exemplary embodiment;

FIG. 3 is a block diagram of the content management server according to the exemplary embodiment;

FIGS. 4A to 4C are diagrams illustrating meta data according to the exemplary embodiment;

FIG. 5 is a block diagram illustrating an example configuration of a client station according to the exemplary embodiment;

FIG. 6 is a diagram illustrating a tree structure according to the exemplary embodiment;

FIG. 7 is a diagram illustrating assignment of video content to containers according to the exemplary embodiment;

FIG. 8 is a flow chart illustrating an example of assigning video content to the tree structure according to the exemplary embodiment;

FIG. 9 is a diagram illustrating allocation of music content to containers according to the exemplary embodiment;

FIG. 10 is a flow chart illustrating an example of allocating music content to the tree structure according to the exemplary embodiment;

FIG. 11 is a diagram illustrating allocation of photo content to containers according to the exemplary embodiment;

FIG. 12 is a diagram illustrating an example allocation of the containers according to the exemplary embodiment;

FIG. 13 is a diagram illustrating a modification of the tree structure according to the exemplary embodiment;

FIG. 14 is a diagram illustrating a display of a video genre list on a client station according to the exemplary embodiment;

FIG. 15 is a diagram illustrating an example of the display of a video content list on the client station according to the exemplary embodiment;

FIG. 16 is a flow chart when the client station acquires a content list of video content from the content management server according to the exemplary embodiment;

FIG. 17 is a diagram illustrating a process sequence performed by the client station when the client station acquires the content list of video content from the content management server according to the exemplary embodiment;

FIG. 18 is a diagram illustrating the display of a music album list on the client station; and

FIG. 19 is a diagram illustrating a process sequence performed by the client station when the client station acquires the content list of music albums from the content management server according to the exemplary embodiment.

### DESCRIPTION OF THE PREFERRED EMBODIMENTS

Exemplary embodiments of the present invention are described in detail below with reference to the accompanying drawings. In the following description and drawings, similar numbering will be used for similar elements having similar functions. Thus, description is not repeated.

### First Exemplary Embodiment

A content sharing system according to a first exemplary embodiment of the present invention is described in detail below.

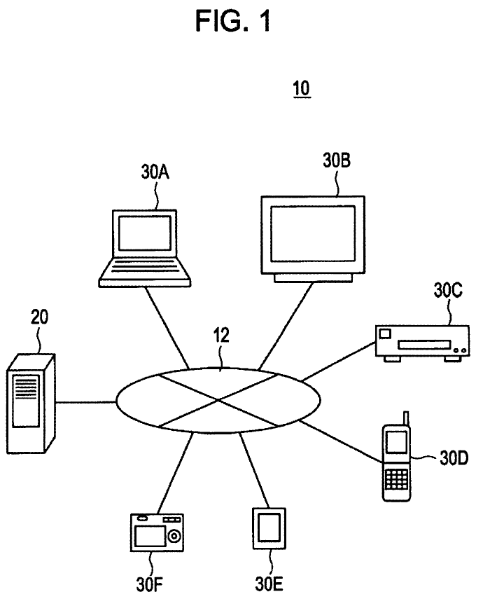

FIG. 1 illustrates a content sharing system 10 according to the present exemplary embodiment. The content sharing system 10 includes a communication network 12, a content management server 20, and a plurality of client stations 30A to 30F. Hereinafter, one of the client stations 30A to 30F is referred to as a “client station 30”.

The communication network 12 connects the content management server 20 with the client station 30 bi-directionally or unidirectionally. Examples of the communication network 12 includes a public line network, such as the Internet, a telephone network, a communication satellite network or a multicast communication network, and a dedicated line network, such as a wide area network (WAN), a local area network (LAN), an Internet protocol-virtual private network (IP-VPN), Ethernet (trade mark), or a wireless LAN. In addition, the communication network 12 may be wired or wireless.

The content management server 20 manages content, such as video content, music content, and photo content using a tree structure defined by the content management server 20 in a predetermined format. In addition, in response to a request from the client station 30 connected to the content management server 20 via the communication network 12, the content management server 20 provides the content and meta data of the content managed by the content management server 20 to the client station 30.

The client station 30 is connected to the content management server 20 via the communication network 12. The client station 30 requests the content management server 20 to send a list of content or the content managed by the content management server 20 to the client station 30. In addition, the client station 30 can execute a variety of content acquired from the content management server 20.

Although a computer station 30A, such as a personal computer (either laptop or desktop), a television receiver 30B, a DVD/HDD recorder 30C, a cell phone 30D, a personal digital assistant (PDA) 30E, and a digital camera 30F are shown in the example shown in FIG. 1 as the client stations 30, the client stations 30 are not limited thereto. For example, any apparatus that has a communication function via a network may be the client station 30. Examples of such apparatuses include home information appliances, such as home game consoles and digital video cameras, and television tuners and decoders. In addition, the client station 30 may be a portable device that a subscriber can carry, such as a portable game console, a personal handyphone system (PHS), or a portable audio/video player.

Furthermore, in the example shown in FIG. 1, the client station 30 is connected to the content management server 20 via the communication network 12. However, the client station 30 may be directly connected to the content management server 20 without the communication network 12 therebetween.

Still furthermore, in FIG. 1, only one content management server 20 is connected to the communication network 12. However, the present embodiment is not limited thereto. A plurality of the content management servers 20 may be connected to the communication network 12.

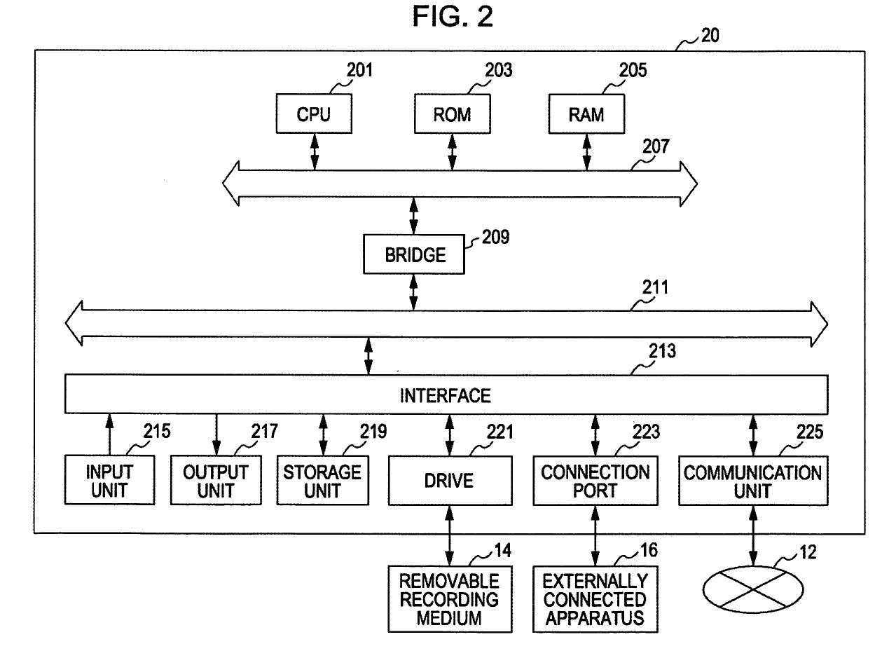

An example hardware configuration of the content management server 20 according to the present exemplary embodiment is described next with reference to FIG. 2.

FIG. 2 illustrates an example hardware configuration of the content management server 20 according to the present embodiment. The content management server 20 includes a central processing unit (CPU) 201, a read only memory (ROM) 203, a random access memory (RAM) 205, a host bus 207, a bridge 209, an external bus 211, an interface 213, an input unit 215, an output unit 217, a storage unit 219, a drive 221, a connection port 223, and a communication unit 225.

The CPU 201 functions as an arithmetic processing unit and a control unit. The CPU 201 performs overall or partial control of the content management server 20 in accordance with a variety of programs stored in the ROM 203, the RAM 205, the storage unit 219, or a removable recording medium 14. The ROM 203 stores a program and arithmetic parameters used by the CPU 201. The RAM 205 temporarily stores the program for the CPU 201 and parameters varying in accordance with the execution of the program. The CPU 201, the ROM 203, the RAM 205, the storage unit 219 are connected to each other via the host bus 207, which consists of an internal bus, such as a CPU bus.

The host bus 207 is connected to the external bus 211, such as a peripheral component interconnect/interface (PCI) bus, via the bridge 209.

For example, but not limited to, the input unit 215 includes a mouse, a keyboard, a touch panel, a button, a switch, and a lever operated by a user. In addition, the input unit 215 may be a remote control using infrared light or radio waves. Alternatively, the input unit 215 may be an externally connected apparatus 16 or the client station 30, such as a cell phone or a PDA, that can control the operation of the content management server 20. The input unit 215 includes an input control circuit that generates an input signal on the basis of information input from the user through the above-described operating member and outputs the generated input signal to the CPU 201. By operating the input unit 215, the user of the content management server 20 can input a variety of data to the content management server 20 and instruct the content management server 20 to perform a variety of operations.

For example, but not limited to, the output unit 217 includes a display unit, such as a cathode ray tube (CRT) display unit, a liquid crystal display (LCD) unit, a plasma display panel (PDP) unit, an electro luminescence (EL) display unit, or a lamp, an audio output unit, such as a speaker or a headphone, and a device, such as a printer, a cell phone, or a facsimile machine, that can visually or acoustically provide information to the user. For example, the output unit 217 outputs playback content data. More specifically, the display unit displays a variety of information, such as playback video data, in the form of text or an image. The audio output unit converts playback audio data to sound and outputs the sound.

The storage unit 219 is an example of a data storage unit of the content management server 20 according to the present embodiment. For example, the storage unit 219 may be a magnetic storage unit device, such as a hard disk drive (HDD), a semiconductor storage device, an optical storage device, or a magnetooptical storage device. The storage unit 219 stores a program executed by the CPU 201, a variety of data, content data, content information and content meta data required for executing the content, and content data acquired externally.

The drive 221 functions as a reader/writer of a storage medium. The drive 221 is incorporated in the content management server 20 or is externally attached to the content management server 20. The drive 221 reads out data stored on the removable recording medium 14, such as a magnetic disk, an optical disk, a magnetooptical disk, or a semiconductor memory, mounted thereon and outputs the readout data to the RAM 205. In addition, the drive 221 can write data onto the removable recording medium 14 mounted thereon. Examples of the removable recording medium 14 include a DVD medium, an HD-DVD medium, a Blue-ray medium, a CompactFlash (CF) (trademark), a memory stick, and a secure digital (SD) memory card. Alternatively, the removable recording medium 14 may be an integrated circuit (IC) card or an electronic device including a contactless IC chip.

The connection port 223 is a port that allows an apparatus to be directly connected to the content management server 20. Examples of the connection port 223 include a universal serial bus (USB) port, an IEEE1394 port (e.g., an i.Link port), a small computer system interface (SCSI) port, an RS-232C port, and an optical audio terminal. When the externally connected apparatus 16 is connected to the connection port 223, the content management server 20 can directly acquire content data from the externally connected apparatus 16 and provide content data to the externally connected apparatus 16.

The communication unit 225 functions as a communication interface including a communication device for connecting the apparatus to, for example, the communication network 12. Examples of the communication unit 225 include a communication card for a wired or wireless local area network (LAN), Bluetooth, and a wireless USB (WUSB), a router for optical communication, a router for an asymmetric digital subscriber line, and a modem for a variety of types of communications. The communication unit 225 allows content and the information about the content to be exchanged with the client station 30. In addition, the communication unit 225 allows content and meta data of the content to be exchanged with the Internet or other communication devices. The communication network 12 to which the communication unit 225 is connected is a wired network or a wireless network. Examples of the communication network 12 include the Internet, a home LAN, an infrared communication network, and a satellite communication network.

The content management server 20 having the above-described configuration can acquire content and the information about the content from a variety of information sources and transmit the content and the information about the content to the client station 30 connected to the communication network 12. In addition, the content management server 20 can receive information about execution of the content from the client station 30. Furthermore, the content management server 20 can acquire content and the information about the content stored in the client station 30. Still furthermore, the content management server 20 allows a user to carry content and the information about the content stored therein using the removable recording medium 14. As described above, using the content management server 20 and the corresponding client station 30, an excellent digital home network can be achieved.

Since the hardware configuration of the client station 30 is similar to that of the content management server 20, description is not repeated.

So far, an example hardware configuration that can provide the functions of the content management server 20 and the client station 30 has been described. General-purpose components may be used for the components of the configuration. Alternatively, a hardware component dedicated for the components of the configuration may be used. Accordingly, the hardware configuration can be changed as needed in accordance with the technological level of the time. It should be noted that the above-described hardware configuration is only an example and the present invention is not limited thereto. In addition, in some use cases, the host bus 207, the external bus 211, and the interface 213 can be removed.

Terms introduced in description of the content sharing system 10 according to the present embodiment are briefly described next.

The term “content” managed by the content management server 20 refers to image data, such as still images and moving images, and audio data, such as music, and data transmitted from a tuner that plays back live streaming data. These types of content are collectively referred to as “AV content”.

The AV content is categorized into three groups: still image data, moving image data, and music data in accordance with the data format of AV content. For example, if the data format of AV content is a JPEG format, the AV content can be determined to be still image data (photo data). If the data format of AV content is one of LPCM, AAC, ATRAC3plus, MP3, and WMA9 formats, the AV content can be determined to be music data. In addition, if the data format of AV content is one of MPEG2, MPEG4:2, MPEG4:10, and WMV9 formats, the AV content can be determined to be moving image data (video data).

Hereinafter, a folder containing an AV content items or a plurality of AV content items is referred to as an “object”. The term “object” also collectively refers to units of data processed by the content management server 20. In addition to a folder containing each of AV content items or a plurality of AV content items, a variety of types of objects can be present. For example, the object may be any content data. Examples of the object include video content including a moving image or a still image, such as a movie, a television program, a video program, or a chart, audio content, such as music, a lecture, or a radio program, game content, document content, or software. The video content may include audio data in addition to image data.

The minimum unit of data of the AV content is referred to an “item”. For example, one music data item, one moving image data item, one still image data item is an “item”. In the case of live streaming data, one channel represents one item.

A superior object of the set of the above-described items is referred to as a “container”. The set of items can be defined in a variety of ways. For example, the set of items is defined in accordance with physical locations of the objects in a storage unit, a logical relationship between the objects, or some category. The container is described in more detail below.

### Content Management Server 20

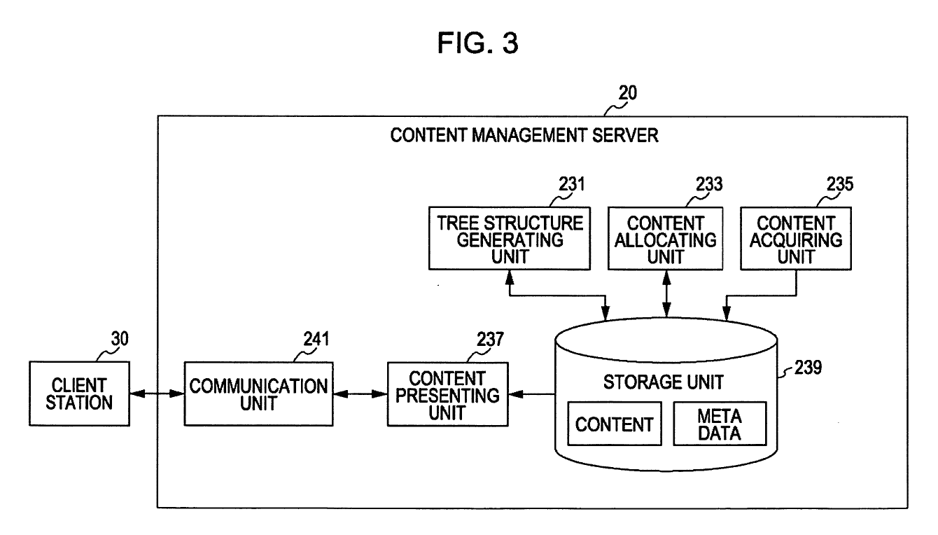

An exemplary configuration of the content management server 20 is described next with reference to FIG. 3. FIG. 3 is a block diagram of the content management server 20 according to the present embodiment.

As shown in FIG. 3, the content management server 20 includes a tree structure generating unit 231, a content allocating unit 233, a content acquiring unit 235, a content presenting unit 237, a storage unit 239, and a communication unit 241.

The tree structure generating unit 231 generates a tree structure containing a plurality of containers arranged in hierarchical levels. Identifiers generated in a predetermined format are associated with the plurality of containers. The identifiers form the tree structure. The tree structure generated by the tree structure generating unit 231 has a “ROOT” container that forms a first level. Below the first level, a plurality of containers are arranged. If the number of levels is greater than 10, a long time is required for the client station 30 to acquire information located at an end of the tree structure. Accordingly, the operating efficiency for a user of the client station 30 decreases. Therefore, it is desirable that the number of levels in the tree structure is less than or equal to 10.

Here, when a branch extends downwardly from a container to another container, the relatively upper container is referred to as a “parent container” and the relatively lower container is referred to as a “child container”. Note that the concept of a parent container and a child container is relative. For example, when three containers are vertically connected with one branch and the uppermost container is defined as a parent container, the middle container is referred to as a child container. However, from the viewpoint of the lowermost container, the lowermost container is a child container of the middle container. Thus, the middle container is referred to as a parent container.

An identifier is assigned to a container contained in the tree structure so that the identifier represents that a tree structure generated by the tree structure generating unit 231 complies with a predetermined format. The identifier serves as an index that represents that the tree structure generated by the tree structure generating unit 231 complies with the predetermined format. A specific example of the identifier is an identifier that indicates the category of the content. By referencing the identifier, the client station 30 accessing the content management server 20 can recognize what container type and content is allocated to the container having that identifier and the lower-level containers thereof. Thus, the client station 30 can acquire the desired content and the meta data of the content without searching the entirety of the tree structure.

As used herein, the term “meta data” refers to data containing the attribute information indicating what is contained in the content and the location information that indicates the location of the content. Examples of the attribute information indicating what is contained in the content include the resource information, the title, the name of the artist, the copyright information of the content. Examples of the location information that indicates the location of the content include an ID used for managing the content and a uniform resource identifier (URI) of the content. The meta data is described in more detail below.

The above-described identifier may be an identifier that is assigned to a container of interest in order to indicate the category of containers or the type of content disposed in the levels lower than that of the container of interest. Thus, it is assured that child containers and grandchild containers having the container of interest as a parent container are containers of the category of the parent container or include content of the category of the parent container. As used herein, examples of the category include the types of content (representation media), such as video content, music content, and photo content, or the types of the attribute information of content, such as a genre, an artist, and an album.

Note that the tree structure generating unit 231 may associate the generated tree structure with the identifiers assigned to the containers in the tree structure and store the tree structure and the identifiers in the storage unit 239.

The content allocating unit 233 allocates the content stored in the storage unit 239 of the content management server 20 to the tree structure generated by the tree structure generating unit 231 using the identifiers assigned to the containers by the tree structure generating unit 231 and the attribute information about the content. When allocating content to the tree structure, the content allocating unit 233 may allocate one content item to a plurality of the containers on the basis of the identifiers assigned to the containers. By allocating the same content item to a plurality of the containers having different identifiers, the client station 30 accessing the content management server 20 can efficiently search for the content item on the basis of the identifiers assigned to the containers.

In addition, the content allocating unit 233 may store the location information about content assigned to the tree structure in the storage unit 239.

The content acquiring unit 235 acquires new content from outside the content management server 20. The content acquiring unit 235 may acquire content from media, such as compact discs (CDs), digital versatile discs (DVDs), or memory cards. Alternatively, the content acquiring unit 235 may have a function of acquiring content by recording a television broadcast program or recording a lecture or a radio program.

Furthermore, the content acquiring unit 235 may store the content acquired in the above-described various manners in the storage unit 239.

In response to a request from the client station 30 connected to the content management server 20, the content presenting unit 237 presents the tree structure, the content being associated with the tree structure, and the meta data of the content to the client station 30. In order to represent that information, the content presenting unit 237 can refer to the content data and the meta data stored in the storage unit 239.

The storage unit 239 stores, for example, content data of content managed by the content management server 20 and the meta data of the content. In addition to these types of data, the storage unit 239 can store the tree structure generated by the tree structure generating unit 231 and data related to allocation of the content performed by the content allocating unit 233. Furthermore, in addition to the data about the content, the storage unit 239 can store a variety of parameters and intermediate results of processing performed by the content management server 20 as needed. The tree structure generating unit 231, the content allocating unit 233, the content acquiring unit 235, and the content presenting unit 237 can freely read and write data from and to the storage unit 239.

The communication unit 241 transmits a variety of information presented by the content presenting unit 237 to the client station 30 via the communication network 12. In addition, the communication unit 241 can receive a request from the client station 30 to the content management server 20. Furthermore, the communication unit 241 can directly receive and transmit information to and from the client station 30 without using the communication network 12.

### Operation of Content Management Server 20

When the content management server 20 is started immediately after the content sharing system 10 is constructed, the tree structure generating unit 231 of the content management server 20 generates a tree structure in a predetermined format. Subsequently, the tree structure generating unit 231 assigns predetermined identifiers to containers contained in the tree structure. Thereafter, the tree structure generating unit 231 stores the tree structure having the identifiers in the storage unit 239.

Subsequently, the content allocating unit 233 associates content received by the content management server 20 in a variety of ways with appropriate locations of the tree structure on the basis of the attribute information about the content and the identifiers assigned to the tree structure. The result of associating the content with the tree structure is stored in the storage unit 239.

Upon acquiring new content from outside the content management server 20, the content acquiring unit 235 stores the acquired content in the storage unit 239. Thereafter, the content allocating unit 233 associates the content acquired by the content acquiring unit 235 with the tree structure in the above-described manner.

The tree structure may be generated by the tree structure generating unit 231 only when the content management server 20 is started for the first time. Alternatively, the tree structure may be periodically generated for a predetermined period of time. In addition, reconstruction of the tree structure may be performed by the owner of the content management server 20 at any time. Furthermore, in addition to the time when new content is introduced into the content management server 20, association of content with the tree structure by the content allocating unit 233 can be performed when the owner of the content management server 20 instructs the reconstruction of the tree structure. In addition, the content management server 20 may reallocate the content to the tree structure at predetermined intervals.

When the client station 30, which is directly connected to the content management server 20 or is connected to the content management server 20 via the communication network 12, sends a request for presentation of the content list to the content management server 20, the communication unit 241 of the content management server 20 receives the request from the client station 30 and delivers the information contained in the request to the content presenting unit 237. The content presenting unit 237 accesses the data stored in the storage unit 239 and delivers, to the communication unit 241, the tree structure and the meta data of the content to be presented. The communication unit 241 transmits the received information and meta data about the tree structure to the client station 30. Thus, the tree structure and the meta data are presented.

In addition, upon receiving a request for acquiring content from the client station 30, the communication unit 241 delivers that information to the content presenting unit 237. The content presenting unit 237 acquires the content data from the storage unit 239 and transmits the content data to the client station 30 via the communication unit 241.

The operation of the content management server 20 is described in detail below with reference to a sequence diagram.

### Structure of Meta Data

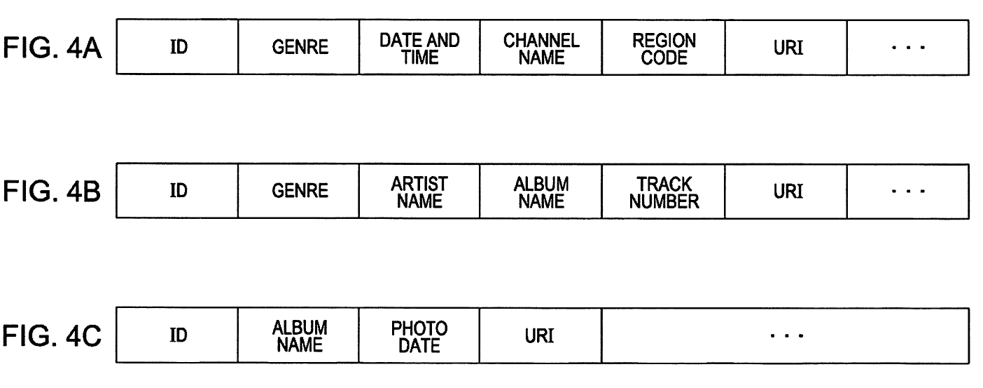

The meta data managed by the content management server 20 according to the present embodiment is described in detail next with reference to FIGS. 4A to 4C. FIGS. 4A to 4C are diagrams illustrating the meta data according to the present embodiment.

FIG. 4A illustrates an example of the meta data of video content. FIG. 4B illustrates an example of the meta data of music content. FIG. 4A illustrates an example of the meta data of photo content.

As shown in FIG. 4A, the meta data of video content includes information, such as an ID and a URI indicating the location of the content and a genre, a data and time, a channel name, and a region code serving as attribute information about the content. In addition to the above-described information, the meta data of video content can include any information, such as a publisher of the content and the language used in the content.

As shown in FIG. 4B, the meta data of music content includes information, such as an ID and a URI indicating the location of the content and a genre, an artist name, an album name, and a track number serving as attribute information about the content. In addition to the above-described information, the meta data of music content can include information about a playlist, information about a recording medium of the content, and the publisher of the content.

As shown in FIG. 4C, the meta data of photo content includes information, such as an ID and a URI indicating the location of the content and an album name, and a photo date. Such information serves as attribute information about the content. The meta data of photo content can further include a variety of information in addition to the above-described information.

While the present embodiment is described with reference to the meta data shown in FIGS. 4A to 4C, the present invention is not limited thereto. The meta data can further include any information. In addition, the layout of information shown in FIGS. 4A to 4C is only an example. Therefore, the layout of information is not limited thereto. Note that the ID is assigned to identify the content managed by the content management server 20. The ID is uniquely assigned to the content so that the content having the same ID is not present in the content management server 20.

### Client Station 30

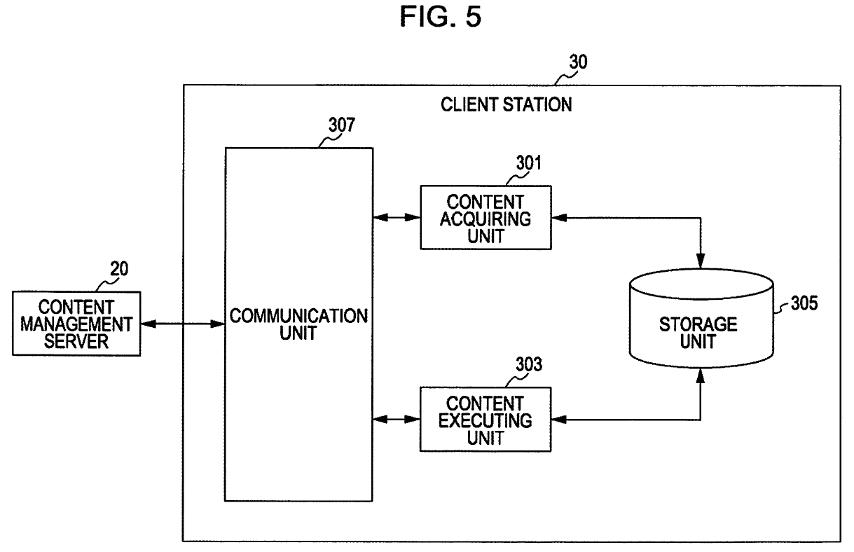

An example configuration of the client station 30 according to the present embodiment is described in detail next with reference to FIG. 5. FIG. 5 is a block diagram illustrating the configuration of the client station 30 according to the present embodiment.

As shown in FIG. 5, according to the present embodiment, the client station 30 includes a content acquiring unit 301, a content executing unit 303, a storage unit 305, and a communication unit 307.

The content acquiring unit 301 requests the content management server 20 to present the tree structure generated by the content management server 20 and the meta data of the content. In addition, the content acquiring unit 301 requests the content management server 20 to send the content data. Thereafter, the content acquiring unit 301 acquires the tree structure, the meta data of the content, and the content data presented by the content management server 20 in response to the request. The content acquiring unit 301 can store the tree structure, the meta data of the content, and the content data acquired from the content management server 20 in the storage unit 305.

The content executing unit 303 executes the content acquired by the client station 30 from the content management server 20. To execute the content, the content executing unit 303 reads out the content data stored in the storage unit 305. As used herein, the term “execution of content” refers to playback of video content or music content and output of the playback video or music to an output unit of the client station 30. For photo content, the term “execution of content” refers to output of a photo to an output unit of the client station 30.

The storage unit 305 stores, for example, the tree structure, content data corresponding to the content, and the meta data of the content acquired by the content acquiring unit 301 from the content management server 20. In addition to these data items, the storage unit 305 can store a variety of parameters and intermediate results of processing performed by the client station 30 as needed. The content acquiring unit 301 and the content executing unit 303 can freely access the storage unit 305.

The communication unit 307 transmits the request received from the content acquiring unit 301 to the content management server 20 via the communication network 12. In addition, the communication unit 307 receives the tree structure, the meta data of the content, and the content data presented to the client station 30 by the content management server 20 via the communication network 12. Furthermore, the communication unit 307 can directly transmit and receive information to and from the content management server 20 without using the communication network 12. Still furthermore, the communication unit 307 can receive a request for transmitting data to outside the client station 30 from the content acquiring unit 301 and the content executing unit 303. The communication unit 307 can also provide data received from outside the client station 30 to the content acquiring unit 301 and the content executing unit 303.

When the client station 30 is connected to the content management server 20 via a home network, it is desirable that the home network supports a protocol known as a universal plug and play (UPnP). UPnP allows easy construction of a network without complicated user operations. Thus, an apparatus connected to the network can receive a service provided by another apparatus connected to the network without requiring users to perform complicated user operations and settings. In addition, UPnP allows an apparatus to be easily connected to the network regardless of the type of operating system (OS) of the apparatus.

### Operation of Client Station 30

When the client station 30 is connected to the content management server 20 via a home network or the communication network 12 or is directly connected to the content management server 20 via a USB port or an IEEE 1394 port, the client station 30 can exchange information with the content management server 20. When the content acquiring unit 301 requests presentation of the tree structure and the meta data of the content to the content management server 20 via the communication unit 307, the content management server 20 presents the requested tree structure and the meta data of the content to the client station 30. The content acquiring unit 301 of the client station 30 receives the tree structure and the meta data of the content presented by the content management server 20 via the communication unit 307. Thereafter, the content acquiring unit 301 stores the received tree structure and meta data of the content in the storage unit 305.

Subsequently, the content acquiring unit 301 of the client station 30 generates a content list regarding content managed by the content management server 20 on the basis of the tree structure and the meta data of the content acquired from the content management server 20. Thereafter, the content acquiring unit 301 outputs the generated list to an output unit of the client station 30.

After the user of the client station 30 selects a content item to be executed from the content list displayed on the output unit, such as a display, the content acquiring unit 301 refers to the meta data of the selected content item so as to acquire the content data from the content management server 20. The content acquiring unit 301 then stores the content data acquired through the communication unit 307 in the storage unit 305.

Subsequently, the content executing unit 303 reads out the content data acquired by the content acquiring unit 301 from the storage unit 305 and executes the content. As a result, the content is displayed on the output unit of the client station 30.

The operation of the client station 30 is described below in more detail with reference to a sequence diagram.

### Entire Tree Structure

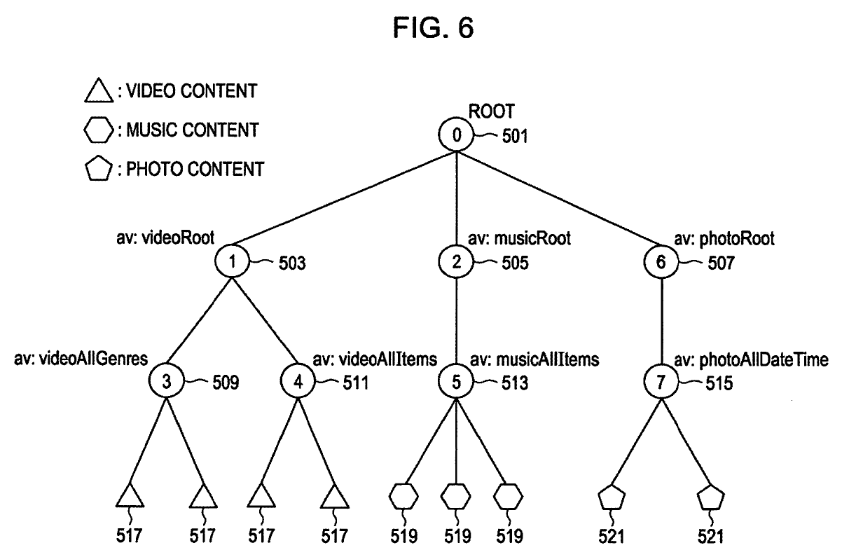

The entire tree structure generated by the content management server 20 according to the present embodiment is briefly described next with reference to FIG. 6. FIG. 6 is a diagram illustrating the tree structure according to the present embodiment.

The content management server 20 holds content, such as image data (e.g., a still image and a moving image) and audio data (e.g., music). The content management server 20 further holds the properties of the content and meta data regarding information about a tuner for executing live streaming data.

For example, AV content is allocated to a tree structure shown in FIG. 6 and is managed using a content directory service (CDS).

In FIG. 6, the circles with numbers 1 to 7 represent containers. The triangular marks represent video content. The hexagonal marks represent music content. The pentagonal marks represent photo content.

In the tree structure shown in FIG. 6, a “ROOT” container 501, which is a container having an ID of “0” assigned thereto, is located in the first level. As used herein, the identifier “ROOT” assigned to the container having an ID of “0” indicates that the container can provide a service called a “container in the highest level” in the tree structure generated by the tree structure generating unit 231 of the content management server 20. This identifier “ROOT” is one of pieces of information that represent device-specific services called “device descriptions”. In the tree structure according to the present embodiment, by assigning an identifier, which is one of the device descriptions, to a container of the tree structure, the client station 30 can efficiently search the tree structure for desired content.

In a second level immediately below the ROOT container 501, a container 503 having an ID of “1”, a container 505 having an ID of “2”, and a container 507 having an ID of “6” are disposed. The device description of the container 503 having an ID of “1” contains an identifier “av: videoRoot”. The device description of the container 505 having an ID of “2” contains an identifier “av: musicRoot”. The device description of the container 507 having an ID of “6” contains an identifier “av: photoRoot”.

The identifier “av: videoRoot” indicates that the container 503 to which this identifier is assigned can provide “only one container located in the highest level among containers associated with video content”. Only video content is associated with the levels below the container to which the identifier “av: videoRoot” is assigned.

The identifier “av: musicRoot” indicates that the container 505 to which this identifier is assigned can provide a service “only one container located in the highest level among containers associated with video content”. Only music content is associated with the levels below the container to which the identifier “av: musicRoot” is assigned.

The identifier “av: photoRoot” indicates that the container 507 to which this identifier is assigned can provide a service “only one container located in the highest level among containers associated with photo content”. Only photo content is associated with the levels below the container to which the identifier “av: photoRoot” is assigned.

By assigning the above-described identifiers to containers, for example, a sub-group called a “video tree” is formed in which only video content is associated with the container 503 to which the identifier “av: videoRoot” is assigned, the containers in the levels below the container 503, and content being associated with these containers. Similarly, a sub-group called a “music tree” is formed in which only music content is associated with the container 505 to which the identifier “av: musicRoot” is assigned, the containers in the levels below the container 505, and content being associated with these containers. A sub-group called a “photo tree” is formed in which only music content is associated with the container 507 to which the identifier “av: photoRoot” is assigned, the containers in the levels below the container 507, and content being associated with these containers.

As described above, by defining the identifiers, the client station 30 can efficiently browse the tree structure of the content management server 20 to search for a container to which video content is associated. For example, the client station 30 searches the tree structure for a container to which the identifier “av: videoRoot” is assigned. Thereafter, the client station 30 browses and searches only levels below this container.

The container 503 having the identifier “av: videoRoot” assigned thereto has, for example, a child container 509 having an identifier “av: videoAllGenres” assigned thereto and a child container 511 having an identifier “av: videoAllItems” assigned thereto. The child container 509 is a container having an ID of “3” assigned thereto. The child container 511 is a container having an ID of “4” assigned thereto.

The identifier “av: videoAllGenres” or “av: videoAllItems” is one type of identifier “av: containerclass” that indicates the type of content allocated to a container. The identifier “av: videoAllGenres” indicates that video content grouped into different genres is associated with this container. Video content 517 grouped using a genre is associated with the levels below the child container 509 having this identifier assigned thereto. In contrast, the identifier “av: videoAllItems” indicates that all the video content is associated with the container. All the video content 517 managed by the content management server 20 is associated with the levels below the child container 511 having this identifier assigned thereto.

The video content 517 allocated to the child container 509 having the identifier “av: videoAllGenres” assigned thereto may be the same as the video content 517 allocated to the child container 511 having the identifier “av: videoAllItems” assigned thereto. The allocation of the video content 517 to the containers is performed on the basis of, for example, the identifiers assigned to the containers. If the video content 517 satisfies a condition for being assigned to a plurality of containers having different identifiers assigned thereto, the video content 517 is disposed below all the containers to which the video content 517 can be assigned.

In FIG. 6, only two containers are disposed in the levels below the container having the identifier “av: videoRoot” assigned thereto. In addition, types of identifiers assigned to the two containers are only two types described above. However, identifiers regarding video content assigned to the tree structure according to the present embodiment are not limited thereto. The video tree with which video content is associated is described in detail below.

The container 505 having the identifier “av: musicRoot” assigned thereto has, for example, a child container 513 having an identifier “av: musicAllItems” assigned thereto. The child container 513 is a container having an ID of “5” assigned thereto.

The identifier “av: musicAllItems” is one type of identifier “av: containerclass” that indicates the type of content assigned to a container. The identifier “av: musicAllItems” indicates that all the music content is associated with the container. All the music content 519 managed by the content management server 20 is associated with the levels below the child container 513 having this identifier assigned thereto.

In FIG. 6, only one container is disposed in the levels below the container having the identifier “av: musicRoot” assigned thereto. In addition, a type of identifier assigned to the container is only one type described above. However, identifiers regarding music content assigned to the tree structure according to the present embodiment are not limited thereto. The music tree with which music content is associated is described in detail below.

The container 507 having the identifier “av: photoRoot” assigned thereto has, for example, a child container 515 having an identifier “av: photoAllDateTime” assigned thereto. The child container 515 is a container having an ID of “7” assigned thereto.

The identifier “av: photoAllDateTime” is one type of identifier “av: containerclass” that indicates the type of content assigned to a container. The identifier “av: photoAllDateTime” indicates that photo content grouped using a photo date is associated with the container. Photo content 521 grouped using a photo date is associated with the levels below the child container 515 having this identifier assigned thereto.

In FIG. 6, only one container is disposed in the levels below the container having the identifier “av: photoRoot” assigned thereto. In addition, a type of identifier assigned to the container is only one type described above. However, identifiers regarding music content assigned to the tree structure according to the present embodiment are not limited thereto. The photo tree with which photo content is associated is described in detail below.

It is determined by the content allocating unit 233 which container of the tree structure shown in FIG. 6 a content item of a plurality of content items managed by the content management server 20 is allocated to on the basis of the identifier assigned to the containers and the attribute information about the content item. For example, on the basis of the data format of a content item, it is first determined under which one of the containers “av: videoRoot”, “av: musicRoot”, and “av: photoRoot” the data is allocated to a level. After a sub-group to which the data is allocated is determined, a container in which the data is disposed is determined on the basis of other information contained in the attribute information of the content, such as the genre information and the date information about the content. An example of the allocation of content to the tree structure is described in detail below.

In the example of the tree structure shown in FIG. 6, the tree structure has eight containers and four levels. However, according to the present embodiment, the number of containers contained in the tree structure is not limited thereto. Any number of containers can be disposed in the tree structure. In addition, the number of levels of the tree structure is not limited to the four levels shown in FIG. 6. The number of levels of the tree structure can be increased up to a tenth level. Note that the IDs assigned to the containers in FIG. 6 are for description purpose only. In the tree structure according to the present embodiment, any unique ID can be assigned to each of the containers.

### Video Tree Structure

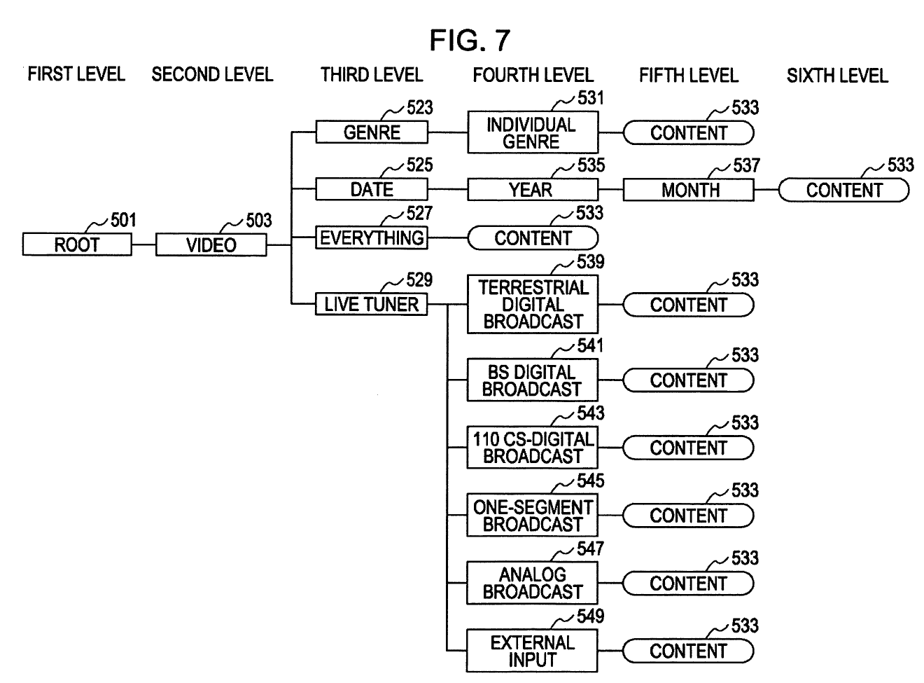

An example of the video tree according to the present embodiment is described in more detail next with reference to FIG. 7. FIG. 7 is a diagram illustrating allocation of video content to containers according to the present embodiment.

As can be seen from the entire structure of a video tree shown in FIG. 7, the video tree has six levels, that is, from a first level to a sixth level. Immediately below the first level in which the ROOT container 501 is disposed, the video container 503 having the “av: videoRoot” identifier assigned thereto is disposed. The video container 503 forms a second level. Four containers are disposed in a third level as child containers of the video container 503. For example, a “genre” container 523, a “date” container 525, an “everything” container 527, and a “live tuner” container 529 are disposed in the third level.

The “genre” container 523 is used for grouping the video content on the basis of the genre information contained in the attribute information of the content. For example, an identifier “av: videoAllGenres” is assigned to the “genre” container 523. For example, the “genre” container 523 has an “individual genre” container 531 as a child container. The “individual genre” container 531 is determined on the basis of an individual genre, such as movie, drama, or variety program. Although only one “individual genre” container 531 is shown in FIG. 7, a plurality of the “individual genre” containers 531 are disposed on the basis of the genre information contained in the attribute information of the content, in practice. In addition, a plurality of video content items 533 corresponding to the genre are associated with a level below each of the “individual genre” containers 531.

The “date” container 525 is used for grouping the video content on the basis of the date information contained in the attribute information of the content. For example, an identifier “av: videoAllDateTime” is assigned to the “date” container 525. For example, a “year” container 535 is disposed on the basis of the captured year of the content as a child container of the “date” container 525. A “month” container 537 is disposed on the basis of the captured month of the content as a child container of the “year” container 535. In the level below the “month” container 537, a plurality of the video content items 533 are disposed on the basis of the date information contained in the attribute information of the content.

In FIG. 7, the “year” container 535 and the “month” container 537 are disposed in the levels below the “date” container 525. However, in the case where the content management server 20 manages a large number of content items having the same photo date (e.g., in the case where the content management server 20 is a video recorder capable of simultaneously recording a plurality of broadcast-program content items), a “year-month-date” container serving as a child container of the “date” container 525 may be disposed in a fourth level in order to group the content items using the year, month, and date of recording. In such a case, the video content items are associated with a fifth level.

The “everything” container 527 is a container to which all the video content items 533 managed by the content management server 20 are allocated. For example, the identifier “av: videoAllItems” is assigned to the “everything” container 527.

The “live tuner” container 529 is a container to which live streaming content is allocated. For example, the identifier “av: videoAllTuners” is assigned to the “live tuner” container 529. For example, the “live tuner” container 529 has child containers, such as a “terrestrial digital broadcast” container 539, a “BS digital broadcast” container 541, a “110 CS-digital broadcast” container 543, a “one-segment broadcast” container 545, an “analog broadcast” container 547, and an “external input” container 549, in accordance with the type of live streaming tuner. The video content items 533 are associated with levels below these containers.

In addition to the client station 30 according to the present embodiment, even when a client station manufactured by a third party is connected to the content management server 20 according to the present embodiment, the client station needs to access the above-described video tree. Therefore, a container that is always present (hereinafter referred to as a “mandatory container”) can be defined. The content management server 20 can freely determine which container is defined to be a mandatory container. For example, when the content management server 20 manages a small number of content items (e.g., several hundreds of content items), the “date” container 525 and the “live tuner” container 529 located in the third level may be determined to be the mandatory containers. In contrast, when the content management server 20 manages a large number of content items (e.g., several thousands or several tens of thousands of content items), the “everything” container 527 and the “live tuner” container 529 may be determined to be the mandatory containers.

In addition, the “individual genre” container 531, the “year” container 535, and the “month” container 537 may have a specific identifier or may not have a specific identifier.

Such a video tree allows the client station 30 to determine the details of a container or content being associated with the levels below a given container by using the identifier assigned to the container when the client station 30 browses or searches for a content item. In addition, when the client station 30 browses or searches for a content item, the client station 30 can sequentially select an appropriate container in each level starting from the first level and further search for a child container of the selected container. Thus, the client station 30 can efficiently browse or search for a desired content item. Unlike an existing tree structure, the client station 30 need not browse the content while going up and down through the levels.

### Allocation of Video Content

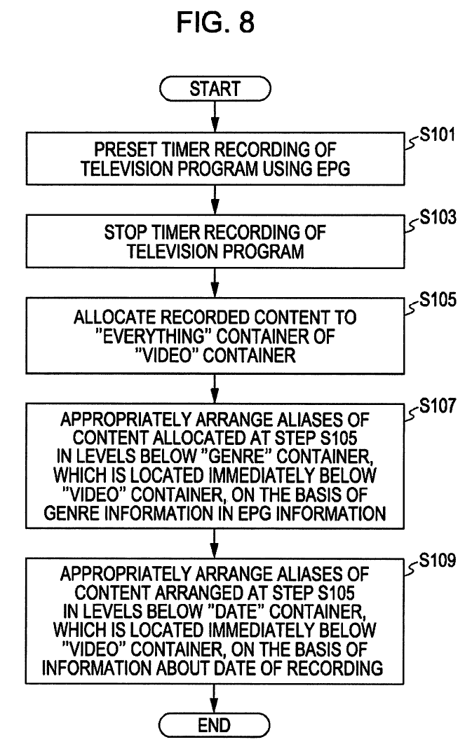

The process flow of allocating video content to the tree structure is described in detail next with reference to FIG. 8. FIG. 8 is a flow chart illustrating an example of allocating video content to the tree structure according to the present embodiment.

In FIG. 8, an example of content allocation is shown in which a video recorder serving as the content management server 20 records a television broadcast program and allocates the recorded content to the tree structure.

The content acquiring unit 235 of a video recorder serving as the content management server 20 presets timer recording of a television program using, for example, an electronic program guide (EPG) (step S101). When the preset start time arrives, the content acquiring unit 235 starts recording the television program. When the preset end time arrives, the content acquiring unit 235 stops recording the television program (step S103). When the timer recording is completed, the content acquiring unit 235 stores content data of the recorded television program in the storage unit 239 of the video recorder. In addition, the content acquiring unit 235 store the attribute information about the content acquired from the EPG in the storage unit 239.

The content allocating unit 233 of the video recorder serving as the content management server 20 allocates the recorded content to the “everything” container 527 located in the level below the video container 503 (step S105). When the container to which the content is to be allocated is determined, the content allocating unit 233 registers the URI of the “everything” container 527 with the location information about the recorded content. The content allocating unit 233 then stores the location information in the storage unit 239.

Subsequently, the content allocating unit 233 appropriately arranges aliases of the content allocated at step S105 in the levels below the “genre” container 523, which is a child content of the video container 503, on the basis of the genre information in the EPG information (step S107). In this case, if a container corresponding to the genre information is present among the “individual genre” containers 531, which are child containers of the “genre” container 523, the content allocating unit 233 allocates an alias to the container corresponding to the genre information. However, if a container corresponding to the genre information is not present, the content allocating unit 233 can generate a new container and allocate an alias to the generated container. After the allocation to the “genre” container is determined, the content allocating unit 233 appends information about the aliases to the location information about the content and stores the location information in the storage unit 239.

Thereafter, the content allocating unit 233 appropriately arranges the aliases of the content arranged at step S105 in the levels below the “date” container 525, which is a child container of the video container 503, on the basis of information about the date of recording (step S109). After the allocation to the “date” container is determined, the content allocating unit 233 appends information about the aliases to the location information about the content and stores the location information in the storage unit 239.

As described above, the content is allocated to all the possible containers in which the content is disposed. The information about the containers to which the content is allocated is managed as the location information about the content. By allocating one content item to a plurality of containers, specific video content can be searched for in accordance with a variety of search conditions. For example, the client station 30 can search for desired video content using the genre of the content as a keyword or using the date of the content as a keyword.

### Music Tree Structure

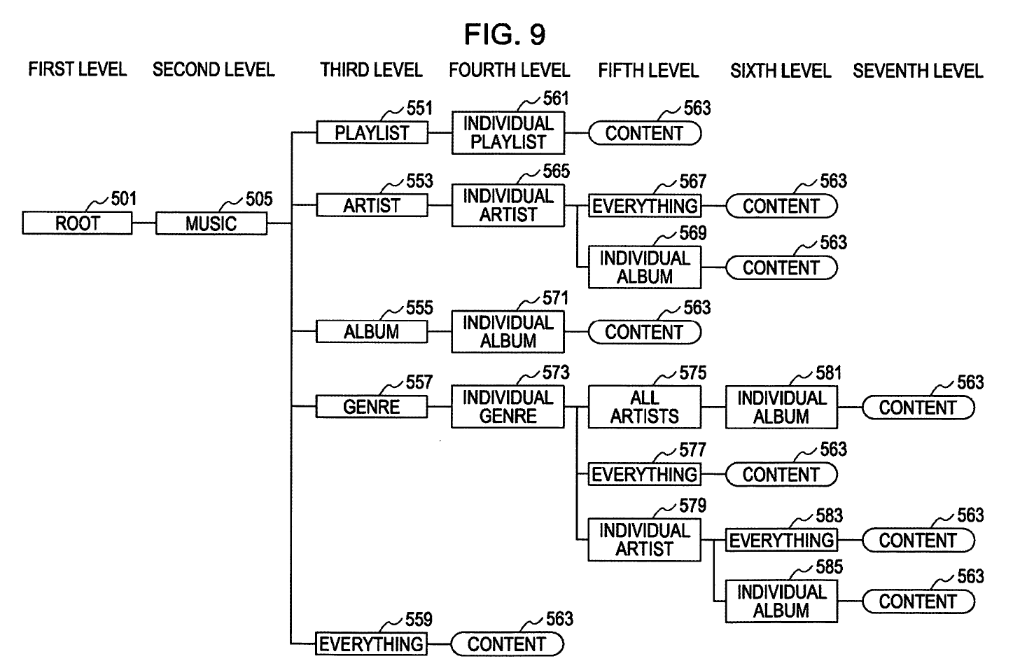

An example of the music tree according to the present embodiment is described in more detail next with reference to FIG. 9. FIG. 9 is a diagram illustrating allocation of music content to containers according to the present embodiment.

As can be seen from the entire structure of a video tree shown in FIG. 9, the music tree has seven levels, that is, from a first level to a seventh level. Immediately below the first level in which the “ROOT” container 501 is disposed, the container 505 having the “av: musicRoot” identifier assigned thereto is disposed. The container 505 forms a second level. Five containers are disposed in a third level as child containers of the container 505. For example, a “playlist” container 551, an “artist” container 553, an “album” container 555, a “genre” container 557, and an “everything” container 559 are disposed in the third level.

The “playlist” container 551 is used for grouping playlists set up by the owner of the content management server 20. For example, an identifier “av: musicAllPlaylists” is assigned to the “playlist” container 551. For example, an “individual playlist” container 561 is disposed as a child container of the “playlist” container 551. Individual playlists set up by the owner of the content management server 20 are grouped into the “individual playlist” containers 561. Although only one “individual playlist” container 561 is shown as the fourth level of FIG. 9, a plurality of the “individual playlist” containers 561 can be disposed, in practice. In addition, a plurality of music content items 563 contained in each of the playlists are associated with the level below the corresponding one of the “individual playlist” containers 561.

The “artist” container 553 is used for grouping the music content on the basis of the artist information contained in the attribute information of the content. For example, an identifier “av: musicAllArtists” is assigned to the “artist” container 553. For example, an “individual artist” container 565 is disposed as a child container of the “artist” container 553 so as to correspond to the name of each of the artists or bands. Although only one “individual artist” container 565 is shown as the fourth level of FIG. 9, a plurality of the “individual artist” containers 565 can be disposed on the basis of the artist information contained in the attribute information of the content, in practice.

Each of the above-described “individual artist” containers 565 may have two child containers, that is, an “everything” container 567 and an “individual album” container 569. All the music content items 563 of the artist corresponding to the parent container of the “everything” container 567 are associated with the “everything” container 567. In addition, the “individual album” containers 569 are disposed so as to correspond to all the albums managed by the content management server 20 for the artist corresponding to the parent container of the “individual album” container 569. Although only one “individual album” container 569 is shown as the fifth level of FIG. 9, a plurality of the “individual album” container 569 can be disposed in accordance with the type of album of the artist corresponding to the parent container, in practice. In addition, the music content items 563 contained in each album are associated with the level below each of the “individual album” containers 569.

The “album” container 555 is used for grouping the music content on the basis of the album information contained in the attribute information of the content. For example, an identifier “av: musicAllAlbums” is assigned to the “album” container 555. An “individual album” container 571 is disposed as a child container of the “album” container 555. All of the albums managed by the content management server 20 regardless of the artist name are assigned to the “individual album” container 571. Although only one “individual album” container 571 is shown as the fourth level of FIG. 9, a plurality of the “individual album” container 571 can be disposed on the basis of the album information contained in the attribute information of the content, in practice. In addition, a plurality of the music content items 563 contained in each of the albums are associated to a level below the “individual album” container 571 corresponding to the album.

The “genre” container 557 is used for grouping the music content on the basis of the genre information contained in the attribute information of the content. For example, an identifier “av: musicAllGenres” is assigned to the “genre” container 557. An “individual genre” container 573 is disposed as a child container of the “genre” container 557. All of the music content items managed by the content management server 20 regardless of the artist name and the album name are allocated to the “individual genre” container 573 on the basis of the genre information contained in the attribute information of the content. Although only one “individual genre” container 573 is shown as the fourth level of FIG. 9, a plurality of the “individual genre” container 573 can be disposed on the basis of the album information contained in the attribute information of the content, in practice.

As child containers of the “individual genre” container 573, an “all artists” container 575 and an “individual artist” container 579 are disposed, for example.

The “all artists” container 575 is used for grouping the music content having the attribute information that contains the genre information identical to the individual genre of the parent container regardless of the artist name. An “individual album” container 581 is disposed as a child container of the “all artists” container 575. All of the albums having the genre same as that of the “individual genre” container 573 are grouped into the “individual album” containers 581. In addition, the music content items 563 contained in each of the albums are associated with the level below the corresponding “individual album” container 581.

An “everything” container 577 is used for grouping all of the music content having the genre information that is the same as the genre of the parent container (i.e., the “individual genre” container 573). All the music content items 563 having the genre information that is the same as the genre information about the “individual genre” container 573 are associated with the level below the “everything” container 577.

The “individual artist” container 579 is used for grouping all of the music content items having the genre information that is the same as the genre of the parent container (i.e., the “individual genre” container 573) for each of the artist names. Although only one “individual artist” container 579 is shown in the fifth level of FIG. 9, a plurality of the “individual artist” containers 579 can be disposed for the artists in the genre that is the same as the individual genre of the parent container, in practice. As child containers of the “individual artist” container 579, an “everything” container 583 and an “individual album” container 585 are disposed for each of the artists. All the music content items 563 of the artist in the “individual artist” container 579 among the music content items having the genre that is the same as the genre of the “individual genre” container 573 are associated with the level below the “everything” container 583. In addition, the music content items 563 of the artist in the “individual artist” container 579 among the music content items having the genre that is the same as the genre of the “individual genre” container 573 are associated with the “individual album” container 585 for each of the albums. The music content items 563 contained in the album are associated with the level below the “individual album” container 585.

The “everything” container 559 is used for grouping all the music content items managed by the content management server 20. For example, an identifier “av: musicAllItems” is assigned to the “everything” container 559. The music content items 563 managed by the content management server 20 are associated with the level below the “everything” container 559. This “everything” container 559 can be used when the client station 30 performs shuffle playback of the music content items.

Such a music tree allows the client station 30 to determine the details of a container and content being associated with the levels below some container by using the identifier assigned to the container when the client station 30 browses or searches for a content item. In addition, when the client station 30 browses or searches for a content item, the client station 30 can sequentially select an appropriate container in each level starting from the first level and further search for a child container of the selected container. Thus, the client station 30 can efficiently browse or search for a desired content item. Unlike an existing tree structure, the client station 30 need not browse the content while going up and down through the levels.

In addition to the client station 30 according to the present embodiment, even when a client station manufactured by a third party is connected to the content management server 20 according to the present embodiment, the client station needs to access the above-described music tree. Therefore, as in the video tree, a mandatory container can be defined in the music tree. The content management server 20 can freely determine which container is defined to be a mandatory container. For example, the “playlist” container 551 located in the third level and the “individual playlist” container 561 in the fourth level, which is a child container of the “playlist” container 551, may be determined to be the mandatory containers.

### Allocation of Music Content

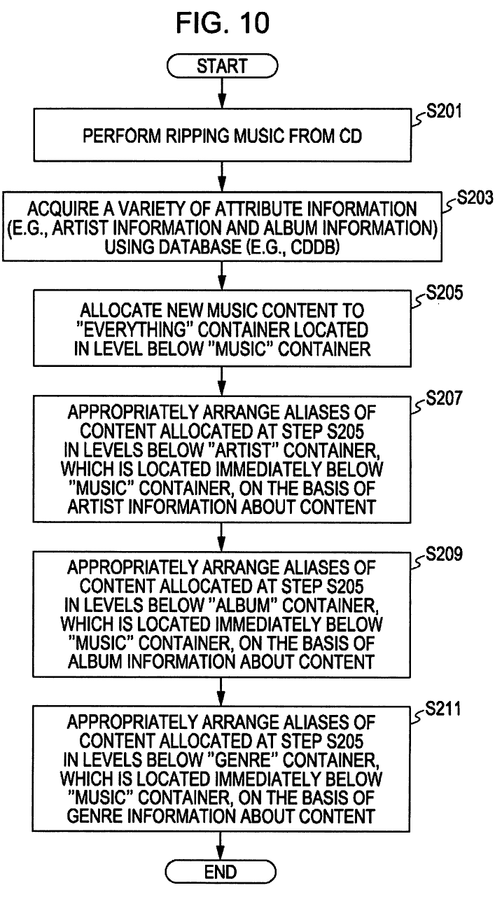

The process flow of allocating music content to the tree structure is described in detail next with reference to FIG. 10. FIG. 10 is a flow chart illustrating an example of allocating music content to the tree structure according to the present embodiment.

In an example of content allocation illustrated in FIG. 10, the content management server 20 acquires music data from a music CD and, subsequently, allocates the acquired content to the tree structure.

The content acquiring unit 235 of the content management server 20 acquires content from a music CD mounted on a drive unit of the content management server 20. Subsequently, the content acquiring unit 235 performs ripping of the content into a predetermined data format (step S201). For example, the data format may be a linear PCM format. Alternatively, the data format may be a format such as AAC, ATRAC3plus, MP3, or WMA9. Upon completion of ripping of the music CD, the content acquiring unit 235 stores the content data of the music CD in the storage unit 239.

Subsequently, the content acquiring unit 235 acquires a variety of attribute information about the music CD, such as the artist information and the album information, using a database, such as the compact disc database (CDDB) (step S203). The content acquiring unit 235 stores the acquired information in the storage unit 239 as the attribute information.

Thereafter, the content allocating unit 233 of the content management server 20 allocates the music content acquired from the music CD to the “everything” container 559 located in the level below the “music” container 505 (step S205). When the container to which the content is to be allocated is determined, the content allocating unit 233 registers the URI of the “everything” container 559 with the location information about the music content. The content allocating unit 233 then stores the location information in the storage unit 239.

The content allocating unit 233 appropriately arranges aliases of the content allocated at step S205 in the levels below the “artist” container 553, which is a child container of the “music” container 505, on the basis of the artist information stored in the storage unit 239 (step S207). In this case, after the content allocating unit 233 arranges the aliases of the content in the “everything” container 567 contained in the “individual artist” container 565, which is a child container of the “artist” container 553, the connection port 223 assigns the aliases to the level below the “individual album” container 569. After the assignment to the “artist” container is determined, the content allocating unit 233 appends information about the aliases to the location information about the content and stores the location information in the storage unit 239.

Thereafter, the content allocating unit 233 appropriately arranges the aliases of the content allocated at step S205 in the levels below the “album” container 555, which is a child container of the “music” container 505, on the basis of the album information acquired from, for example, the CDDB and stored in the storage unit 239 (step S209). In this case, the content allocating unit 233 assigns the aliases to the level below the “individual album” container 571, which is a child container of the “album” container 555. After the assignment to the “album” container is determined, the content allocating unit 233 appends information about the aliases to the location information about the content and stores the location information in the storage unit 239.

Subsequently, the content allocating unit 233 appropriately arranges the aliases of the content allocated at step S205 in the levels below the “genre” container 557, which is a child container of the “music” container 505, on the basis of the genre information acquired from, for example, the CDDB and stored in the storage unit 239 (step S211). In this case, the content allocating unit 233 arranges the aliases of the content in the “everything” container 577 contained in the “individual genre” container 573, which is a child container of the “genre” container 557, first. In addition, the content allocating unit 233 references the album information stored in the storage unit 239 so as to dispose the “individual album” container 581 in the level below the “all artists” container 575 and dispose the alias. Furthermore, the content allocating unit 233 assigns the aliases to the “everything” container 583, which is a child container of the “individual artist” container 579, on the basis of the artist information stored in the storage unit 239, and assigns the aliases to the level below the “individual album” container 585 on the basis of the album information. After the assignment to the “genre” container is determined, the content allocating unit 233 appends information about the aliases to the location information about the content and stores the location information in the storage unit 239.

As described above, the content is allocated to all the possible containers in which the content is disposed. The information about the containers to which the content is allocated is managed as the location information about the content. By allocating one content item to a plurality of containers, specific music content can be searched for in accordance with a variety of search conditions. For example, the client station 30 can search for desired music content using the genre of the content as a keyword or using the artist name of the content as a keyword.

### Photo Tree Structure

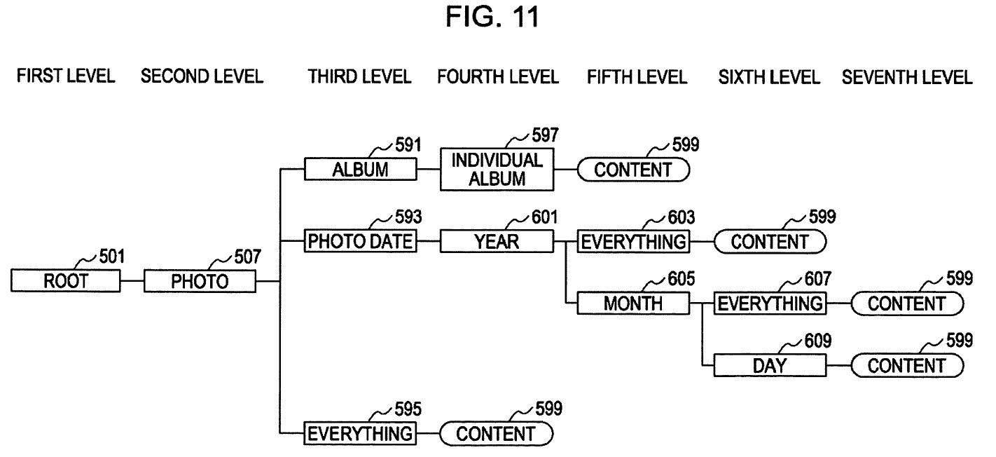

An example of the photo tree according to the present embodiment is described in more detail next with reference to FIG. 11. FIG. 11 is a diagram illustrating allocation of photo content to the tree structure according to the present embodiment.

As can be seen from the entire structure of a photo tree shown in FIG. 11, the photo tree has seven levels, that is, from a first level to a seventh level. Immediately below the first level in which the ROOT container 501 is disposed, the photo container 507 having the “av: photoRoot” identifier assigned thereto is disposed. The photo container 507 forms a second level. Three containers are disposed in a third level as child containers of the photo container 507. For example, an “album” container 591, a “photo date” container 593, and an “everything” container 595 are included in the third level.

The “album” container 591 is used for grouping photo content on the basis of the album information contained in the attribute information about the content. For example, an identifier “av: photoAllAlbums” is assigned to the “album” container 591. An “individual album” container 597 is disposed as a child container of the “album” container 591. All of the albums managed by the content management server 20 are assigned to the “individual album” containers 597. Although only one “individual album” container 597 is shown in the fourth level of FIG. 11, a plurality of the “individual album” containers 597 can be disposed on the basis of the album information contained in the attribute information about the content, in practice. In addition, a plurality of photo content items 599 contained in each of the albums are associated with the level below the corresponding one of the “individual album” containers 597.

The “photo date” container 593 is used for grouping the photo content on the basis of the date information contained in the attribute information about the content. For example, an identifier “av: photoAllDateTime” is assigned to the “photo date” container 593. A “year” container 601 is disposed as a child container of the “photo date” container 593. The photo content items managed by the content management server 20 are grouped into the “year” container 601 using the photograph years of the photo content items. In addition, an “everything” container 603 is disposed as a child container of the “year” container 601. The photo content items captured in the same year are associated with the “everything” container 603 regardless of the photograph month and day. Furthermore, a “month” container 605 is disposed in the fifth level in which the “everything” container 603 is disposed. The photo content captured in the same year is disposed in the “month” container 605 corresponding to the photograph month. All of the photo content items 599 captured in the same year are associated with the level below the “everything” container 603.

In addition, an “everything” container 607 is disposed as a child container of the “month” container 605. The photo content captured in the same month is associated with the “everything” container 607 regardless of the photograph day. Furthermore, a “day” container 609 is disposed in the sixth level in which the “everything” container 607 is disposed. The photo content captured in the same day is associated with the “day” container 609 corresponding to that photograph day. All of the photo content items 599 captured in the same month are associated with the level below the “everything” container 607. The photo content items 599 grouped using the photograph day are associated with the level below the “day” container 609.

In FIG. 11, below the “photo date” container 593, the “year” container 601 is disposed in the fourth level. The “everything” container 603 and the “month” container 605 are disposed in the fifth level. The “everything” container 607 and the “day” container 609 are disposed in the sixth level. However, the containers disposed below the “photo date” container 593 may be changed in accordance with the number of photo content items managed by the content management server 20.

For example, if the number of photo content items captured in the same day is not large, the “year” container 601 may be disposed in the fourth level. In addition, the “everything” container 607 and a “month and day” container may be disposed as child containers of the “year” container 601. In contrast, if the number of photo content items managed by the content management server 20 is small, only a “year-month-day” container may be disposed as a child container of the “photo date” container 593.

The “everything” container 595 is disposed in the third level. All of the photo content items managed by the content management server 20 are associated with the “everything” container 595 regardless of the attribute information of the photo content items. All of the photo content items are disposed in the fourth level below the “everything” container 595.

In addition to the client station 30 according to the present embodiment, even when a client station manufactured by a third party is connected to the content management server 20 according to the present embodiment, the client station needs to access the above-described photo tree. Therefore, as in the video tree and the music tree, a mandatory container can be defined in the photo tree. The content management server 20 can freely determine which container is defined to be a mandatory container. For example, the “album” container 591, the “everything” container 595, and the “individual album” container 597 may be determined to be the mandatory containers.

Such a photo tree allows the client station 30 to determine the details of a container or content being associated with the levels below some container by using the identifier assigned to the container when the client station 30 browses or searches for a content item. In addition, when the client station 30 browses or searches for a content item, the client station 30 can sequentially select an appropriate container in each level starting from the first level and further search for a child container of the selected container. Thus, the client station 30 can efficiently browse or search for a desired content item. Unlike an existing tree structure, the client station 30 need not browse the content while going up and down through the levels.

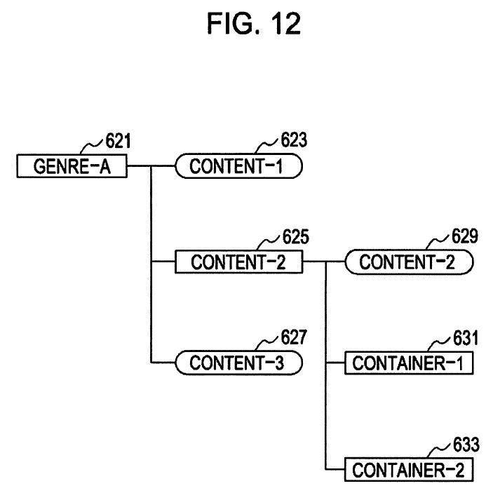

In the tree structure according to the present embodiment, for example, containers can be disposed in a level in which content items are defined to be disposed, as shown in FIG. 12. In FIG. 12, a “content-1” content item 623, a “content-2” container 625, and a “content-3” content item 627 are disposed in the level immediately below a “genre-A” container 621. In such a case, a “content-2” content item 629 needs to be disposed in the level immediately below the “content-2” container 625. In addition, in the level below the “content-2” container 625, a “container-1” container 631 and a “container-2” container 633 can be disposed. However, even in the above-described case, it is desirable that the number of levels in the tree structure is less than or equal to 10.

In the above-described tree structure, the “ROOT” container 501 serving as the first level is disposed. However, if the content management server 20 manages only one media class (e.g., only video content, only music content, or only photo content), the ROOT container 501 disposed in the first level may be removed.

### First Modification

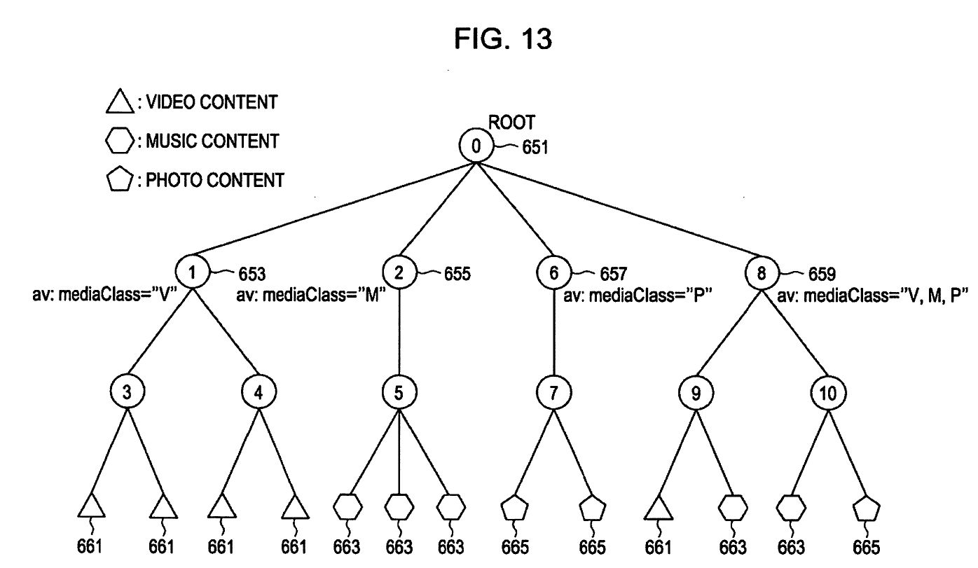

A first modification of the tree structure according to the present embodiment is briefly described next with reference to FIG. 13. FIG. 13 is a diagram illustrating the first modification of the tree structure according to the present embodiment.

In the tree structure shown in FIG. 13, a “ROOT” container 651 is located in a first level. As child containers of the “ROOT” container 651, a container 653 having an ID “1” assigned thereto, a container 655 having an ID “2” assigned thereto, a container 657 having an ID “6” assigned thereto, and a container 659 having an ID “8” assigned thereto are disposed. These child containers form a second level. An identifier “av: mediaclass” is assigned to these child containers. The identifier “av: mediaClass” indicates which media class of content a sub-tree structure formed from containers located in the levels below the container having this identifier assigned thereto can contain. The media class of content represents the type of the content, such as a photo, a moving image, or music.

The identifier “av: mediaClass” is used together with text that indicates the type of content that the sub-tree can contain. For example, “av: mediaClass=“V””, “av: mediaclass=“M””, “av: mediaclass=“P””, and “av: mediaClass=“O”” are used. In the identifier “av: mediaClass”, the text that indicates the type of content may be a single letter or a combination of two or more letters.

The above-described letter “V” represents the initial letter of “Video” and indicates that video content, such as a moving image, can be contained in the sub-tree below the container having the identifier assigned thereto. The above-described letter “M” represents the initial letter of “Music” and indicates that music content, such as pure audio content, can be contained in the sub-tree below the container having the identifier assigned thereto. The above-described letter “P” represents the initial letter of “Photo” and indicates that still-image content, such as photo content, can be contained in the sub-tree below the container having the identifier assigned thereto. The above-described alphabet “O” represents the initial letter of the word “Other” and indicates that none of pure audio content, still-image content, and video content, such as a moving image, can be contained in the sub-tree below the container having the identifier assigned thereto.

In the tree structure shown in FIG. 13, an identifier “av: mediaclass=“V”” is assigned to the container 653 having the ID “1”. Accordingly, only video content 661 can be present in a container having an ID “3”]and a container having an ID “4”, which are located in the level below the container 653.

An identifier “av: mediaClass=“M”” is assigned to the container 655 having the ID “2”. Accordingly, only music content 663 can be present in a container having an ID “5”, which is located in the level below the container 655.

An identifier “av: mediaclass=“P”” is assigned to the container 657 having the ID “6”. Accordingly, only photo content 665 can be present in a container having an ID “7”, which is located in the level below the container 657.

In the tree structure shown in FIG. 13, an identifier “av: mediaclass=“V, M, P”” is assigned to the container 659 having the ID “8”. Accordingly, the video content 661, the music content 663, and the photo content 665 can be present in a container having an ID “9” and a container having an ID “10”, which are located in the level below the container 659.

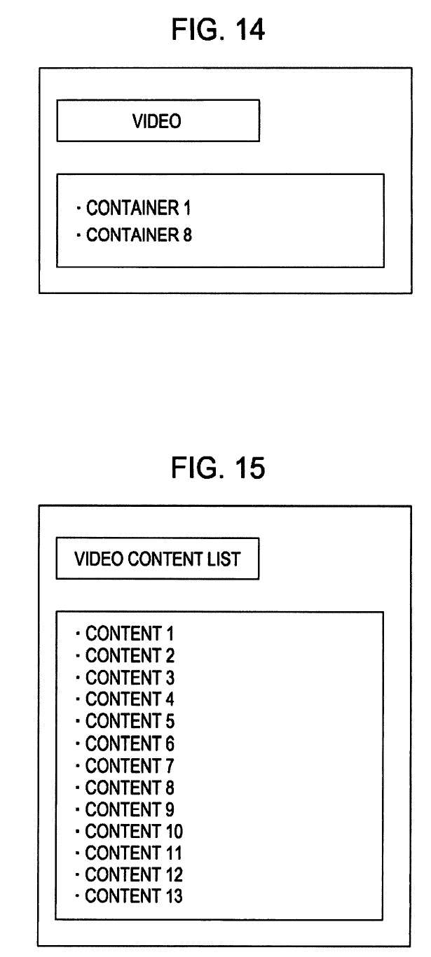

As described above, by assigning the identifier “av: mediaclass” to a container located in the highest level of a sub-tree structure, the client station 30 can efficiently browse the desired content of a specific media class. For example, as shown in FIG. 14, when the client station 30 accesses the content management server 20 having the tree structure shown in FIG. 13 and browses video content, the client station 30 need not search for all of the containers. The client station 30 can search for only containers to which an identifier “av: mediaclass=“V”” is assigned. Thus, the client station 30 can efficiently browse the content. In the example shown in FIG. 13, only two containers, that is, a container 653 (container 1) having the ID “1” and a container 653 (container 8) having the ID “8” have the identifier “av: mediaclass=“V””. Accordingly, a list as shown in FIG. 14 is displayed on the output unit of the client station 30.

### Acquisition of Video Content List Performed by Client Station 30

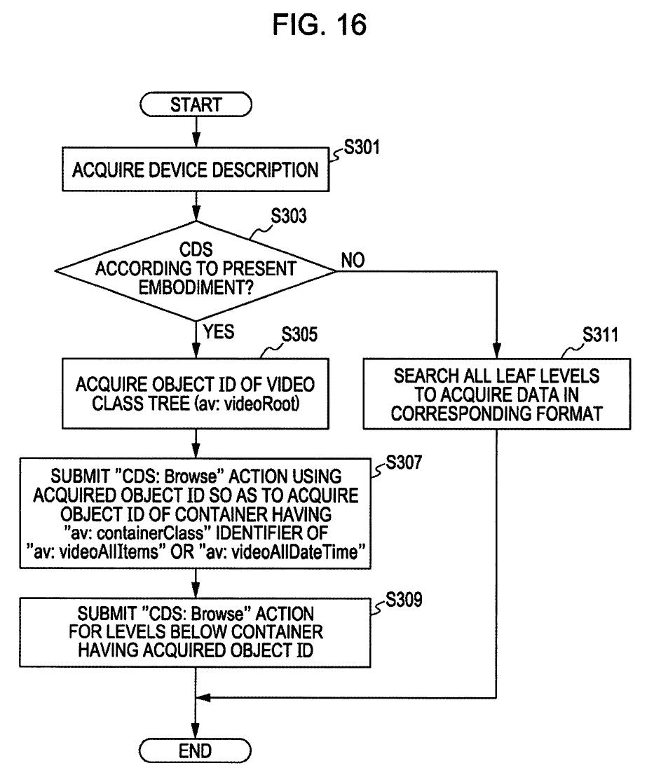

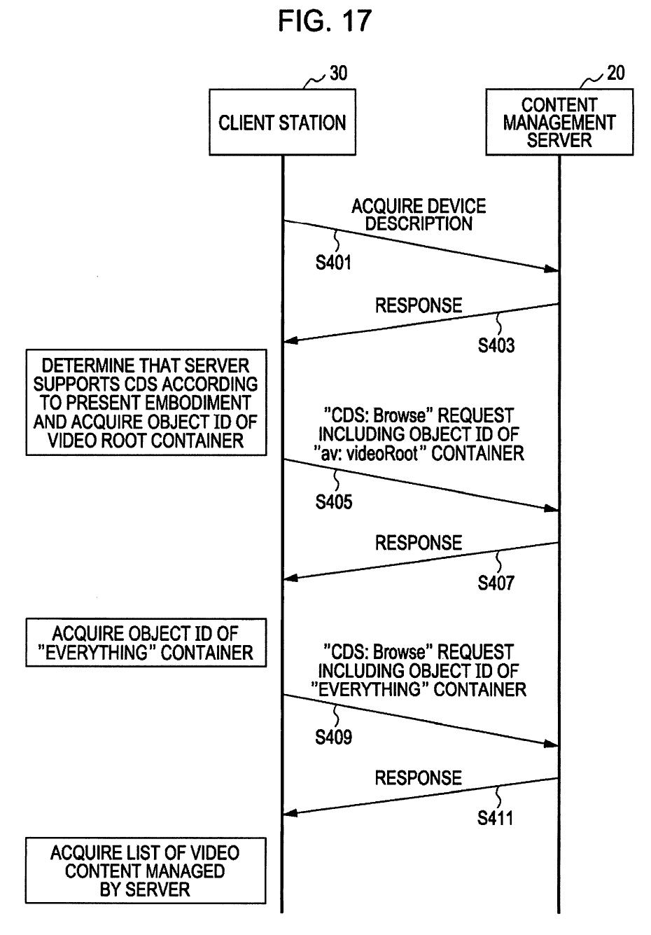

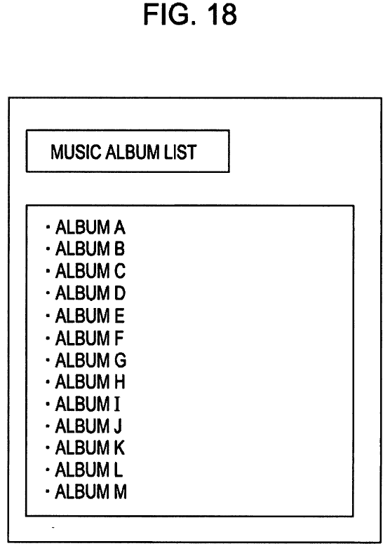

The client station 30 according to the present embodiment accesses the content management server 20 to acquire information about content. As an example, acquisition of a video content list performed by the client station 30 is described in detail next with reference to FIGS. 15 to 17. FIG. 15 is a diagram illustrating the display of a video content list acquired from the content management server 20 by the client station 30. FIG. 16 is a flow chart when the client station 30 according to the present embodiment acquires a content list of video content from the content management server 20. FIG. 17 is a diagram illustrating a process sequence performed by the client station 30 according to the present embodiment when the client station 30 acquires the content list of video content from the content management server 20.

After the client station 30 accesses the content management server 20 and acquires a video content list, the list of the video content managed by the content management server 20 is displayed on the output unit of the client station 30, as shown in FIG. 15. When the client station 30 acquires the content list from the content management server 20, the procedure shown in FIG. 14 is performed.

The client station 30 connected to the content management server 20 via, for example, home network (e.g., Ethernet (trade mark)) exchanges definition files having, for example, an extended markup language (XML) format with the content management server 20. Thus, the client station 30 and the content management server 20 are mutually recognized. Subsequently, the client station 30 acquires a device description from the content management server 20 (step S301). The device description of the content management server 20 contains information about the type of CDS used for the content management of the content management server 20. The client station 30 refers to the device description acquired at step S301 to determine whether the content management server 20 uses the CDS according to the present embodiment (step S303).

If it is determined that the content management server 20 uses the CDS according to the present embodiment, the content acquiring unit 301 of the client station 30 searches the tree structure generated by the content management server 20 so as to acquire an ID (object ID) of a container having an identifier “av: videoRoot” assigned thereto (step S305).

Subsequently, the content acquiring unit 301 submits a “CDS: Browse” action using the acquired object ID so as to browse the tree structure managed by the content management server 20 (step S307). The content acquiring unit 301 then acquires an ID (object ID) of a container having an “av: containerclass” identifier of “av: videoAllItems” or “av: videoAllDateTime” (step S307).

Using the ID (object ID) of the container having an “av: containerClass” identifier of “av: videoAllItems” or “av: videoAllDateTime” acquired at step S307, the content acquiring unit 301 submits a “CDS: Browse” action for the levels below the container so as to acquire a video content list (step S309). The client station 30 displays the acquired video content list on the output unit thereof. Thus, the content list shown in FIG. 15 can be obtained.

Exchange of information about the acquisition of the video content list between the client station 30 and the content management server 20 is described next with reference to FIG. 17.

When the client station 30 is connected to the content management server 20, the client station 30 and the content management server 20 exchange definition files having, for example, an extended markup language (XML) format with each other. Thus, the client station 30 and the content management server 20 are mutually recognized. Subsequently, the client station 30 attempts to acquire a device description from the content management server 20 (step S401). In response to a request from the client station 30, the content management server 20 transmits the device description thereof to the client station 30 (step S403).

The client station 30 refers to the acquired device description so as to determine that the content management server 20 manages content using the CDS according to the present embodiment. Thereafter, the client station 30 requests the content management server 20 to present the object ID of a container having an identifier “av: videoRoot” assigned thereto. In response to this request, the content management server 20 presents the object ID of a container having an identifier “av: videoRoot” assigned thereto to the client station 30 (step S403).

Subsequently, the client station 30 submits a “CDS: Browse” request including the acquired object ID of the container having an identifier “av: videoRoot” assigned thereto to the content management server 20 (step S405).

In response to this request from the client station 30, the content management server 20 permits the client station 30 to browse the tree structure managed by the content management server 20 (step S407). The client station 30 browses a sub-tree structure below the container having an identifier “av: videoRoot” assigned thereto in the tree structure managed by the content management server 20. As a result, the client station 30 can acquire, for example, the object ID of an “everything” container having an identifier “av: videoAllItems” assigned thereto.

Subsequently, the client station 30 submits a “CDS: Browse” request including the acquired object ID of the “everything” container to the content management server 20 (step S409).

In response to this request from the client station 30, the content management server 20 transmits a list of content items allocated to the levels below the “everything” container together with the meta data of the content items to the client station 30 (step S411). As a result, the client station 30 can acquire the list of video content managed by the content management server 20.

After the user of the client station 30 selects the content item to be executed from the video content list, the content acquiring unit 301 of the client station 30 requests the content management server 20 to transmit the content data on the basis of the location information (e.g., the URI of the content) contained in the meta data of the content item. Upon receipt of this request, the content management server 20 transfers the content data to the client station 30. Upon receipt of the content data, the client station 30 stores the received content in the storage unit 305, and the content executing unit 303 plays back the received content.

### Acquisition of Music Content List Performed by Client Station 30

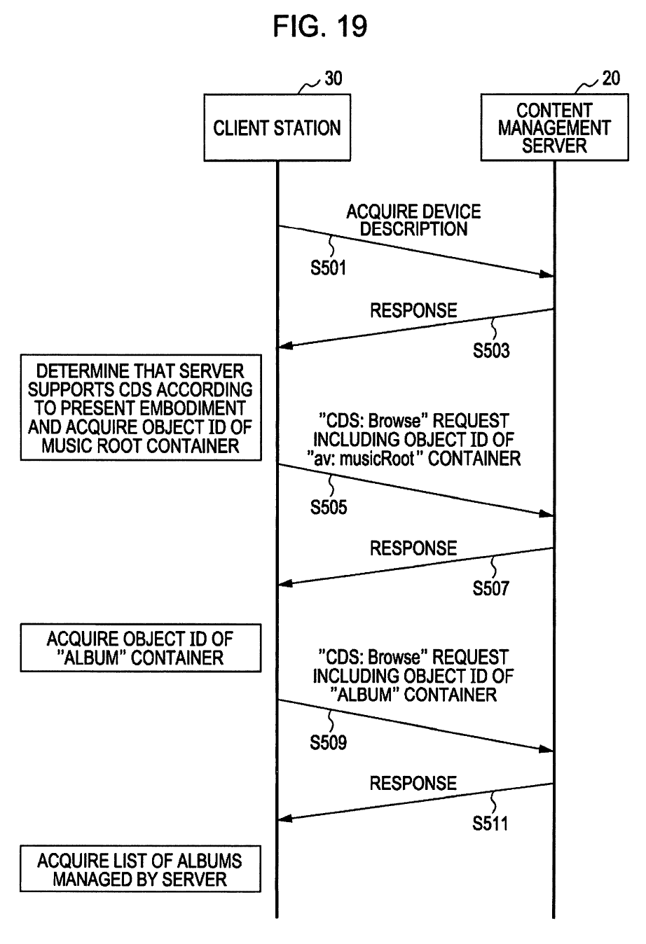

The client station 30 according to the present embodiment accesses the content management server 20 to acquire information about content. As an example, acquisition of a music album list performed by the client station 30 is described in detail next with reference to FIGS. 18 and 19. FIG. 18 is a diagram illustrating the display of a music album list acquired from the content management server 20 by the client station 30. FIG. 19 is a flow chart when the client station 30 according to the present embodiment acquires an album list of music content from the content management server 20.

After the client station 30 accesses the content management server 20 and acquires a music album list, the list of the music album managed by the content management server 20 is displayed on the output unit of the client station 30, as shown in FIG. 18. When the client station 30 acquires the content list from the content management server 20, the procedure shown in FIG. 19 is performed.

The client station 30 connected to the content management server 20 via, for example, a home network (e.g., Ethernet (trade mark)) exchanges definition files having, for example, an extended markup language (XML) format with the content management server 20. Thus, the client station 30 and the content management server 20 are mutually recognized. Subsequently, the client station 30 attempts to acquire a device description from the content management server 20 (step S501). In response to the request from the client station 30, the content management server 20 transmits the device description thereof to the client station 30 (step S503).

The client station 30 refers to the acquired device description to determine whether the content management server 20 uses the CDS according to the present embodiment. If it is determined that the content management server 20 uses the CDS according to the present embodiment, the client station 30 requests the content management server 20 to present an object ID of a container having an identifier “av: musicRoot” assigned thereto again. In response to this request, the content management server 20 presents the object ID of a container having an identifier “av: musicRoot” assigned thereto (step S503).

Subsequently, the client station 30 submits a “CDS: Browse” request including the acquired object ID of the container having an identifier “av: musicRoot” assigned thereto to the content management server 20 (step S505).

In response to this request from the client station 30, the content management server 20 permits the client station 30 to browse the tree structure managed by the content management server 20 (step S507). The client station 30 browses a sub-tree structure below the container having the identifier “av: musicRoot” assigned thereto in the tree structure managed by the content management server 20. As a result, the client station 30 can acquire, for example, the object ID of an “album” container having an identifier “av: musicAllItems” assigned thereto.

Subsequently, the client station 30 submits a “CDS: Browse” request including the acquired object ID of the “album” container to the content management server 20 (step S509).

In response to this request from the client station 30, the content management server 20 transmits a list of content items associated with the levels below the “album” container together with the meta data of the content items to the client station 30 (step S511). As a result, the client station 30 can acquire the list of albums of the music content managed by the content management server 20.

After the user of the client station 30 selects a content item to be executed from the album list, the content acquiring unit 301 of the client station 30 requests the content management server 20 to transmit the content data on the basis of the location information (e.g., the URI of the content) contained in the meta data of the content item. Upon receipt of this request, the content management server 20 transfers the content data to the client station 30. Upon receipt of the content data, the client station 30 stores the received content in the storage unit 305, and the content executing unit 303 plays back the received content.

While the embodiment above has been described with reference to the case where the tree structure generating unit 231 generates a tree structure having branches that expand downwardly, the tree structure is not limited thereto. For example, the branches may expand upwardly, towards the right, or towards the left.

In the present specification, the steps described in the flow charts include not only processes executed in the above-described sequence described in the flow charts, but also processes that may be executed in parallel or independently (e.g., processes according to parallel processing or object processing).

It should be understood by those skilled in the art that various modifications, combinations, sub-combinations and alterations may occur depending on design requirements and other factors insofar as they are within the scope of the appended claims or the equivalents thereof.

What is claimed is:

1. A content sharing system comprising:
a plurality of client apparatuses, each including a content acquiring unit; and
one or more content management servers configured to manage a plurality of content items, the client apparatuses sharing the plurality of content items, the content management server including a storage unit configured to store meta data of the content items, a tree structure generating unit configured to generate a tree structure including a plurality of containers arranged in hierarchical levels, each container having an identifier representing a type of content assigned thereto, a content allocating unit configured to allocate the content items to the containers on the basis of the meta data and the identifier, and a content presenting unit configured to present the tree structure having the content items allocated thereto to the client apparatus;
wherein the content acquiring unit acquires the tree structure from the content management server and acquires the one or more content items from the content management server on the basis of the acquired tree structure.

2. A content management server for managing a plurality of content items and providing meta data of the content items to a client apparatus in response to a request from the client apparatus, comprising:
a storage unit configured to store the meta data;
a tree structure generating unit configured to generate a tree structure including a plurality of containers arranged in hierarchical levels, each container having an identifier representing a type of content assigned thereto;
a content allocating unit configured to allocate the content items to the containers on the basis of the meta data and the identifier; and
a content presenting unit configured to present the tree structure having the content items allocated thereto to the client apparatus.

3. The content management server according to claim 2, wherein the identifier indicates the type of containers or the type of content items allocated to levels below the container having the identifier assigned thereto.

4. The content management server according to claim 2, wherein the content allocating unit allocates one of the content items to a plurality of containers of the tree structure on the basis of the identifier.

5. The content management server according to claim 2, wherein the meta data includes attribute information about the content item and location information about the content item.

6. The content management server according to claim 2, further comprising:
a content acquiring unit configured to acquire a new content item from outside the content management server.

7. The content management server according to claim 2, wherein the number of levels of the tree structure is less than or equal to 10.

8. The content management server according to claim 2, wherein the levels of the tree structure include levels in which only the containers are disposed and levels in which both the containers and the content items are disposed.

9. The content management server according to claim 2, wherein an identifier used for grouping the content items on the basis of the type of content item is assigned to a container included in a second level of the tree structure.

10. The content management server according to claim 2, wherein an identifier used for grouping the content items on the basis of the attribute information about the content item contained in the meta data is assigned to a container included in a third level of the tree structure.

11. A client apparatus communicatable with a content management server, comprising:
a content acquiring unit configured to request the content management server to present a tree structure generated by the content management server, the tree structure including a plurality of containers arranged in hierarchical levels, each container having an identifier indicating the type of content item so as to acquire the tree structure, the content acquiring unit acquiring one of the content items on the basis of the acquired tree structure.

12. The client apparatus according to claim 11, wherein the content acquiring unit searches the tree structure using the identifiers assigned to the containers so as to acquire the meta data of the one of the content items and acquire the one of the content items.

13. The client apparatus according to claim 12, wherein the content acquiring unit generates a content list of the content items managed by the content management server on the basis of the meta data acquired from the content management server.

14. The client apparatus according to claim 11, further comprising:
a content executing unit configured to execute the content item acquired by the content acquiring unit.

15. A method for managing a plurality of content items, comprising the steps of:
generating a tree structure including a plurality of containers arranged in hierarchical levels, each container having an identifier representing a type of content assigned thereto;
allocating the content items to the containers on the basis of meta data of the content items and the identifiers; and
presenting the tree structure having the content items allocated thereto to a client apparatus in response to a request from the client apparatus.

16. A method for acquiring content from a content management server through communication with the content management server, comprising the steps of:
requesting the content management server to present a tree structure generated by the content management server, the tree structure including a plurality of containers arranged in hierarchical levels, each container having an identifier indicating the type of content item so as to acquire the tree structure; and
acquiring one of the content items on the basis of the acquired tree structure.

17. A computer-readable program comprising program code for causing a computer to execute the steps of:
storing meta data of content;
generating a tree structure including a plurality of containers arranged in hierarchical levels, each container having an identifier representing a type of content assigned thereto;
allocating the content to the containers on the basis of the meta data and the identifier; and
presenting the tree structure having the content allocated thereto to a client apparatus.

18. A computer-readable program comprising program code for causing a computer to execute the steps of:
requesting a content management server to present a tree structure generated by the content management server, the tree structure including a plurality of containers arranged in hierarchical levels, each container having an identifier indicating a type of content item so as to acquire the tree structure; and
acquiring one of the content items on the basis of the acquired tree structure.
